(19) United States
(12) Patent Application Publication
(10) Pub. No.: US 2003/0144946 A1
(43) Pub. Date: Jul. 31, 2003

(54) Delivery information processing method and apparatus

(75) Inventors: Tomohisa Misawa, Kawasaki (JP); Fusayuki Kuniyoshi, Naha (JP); Michihiko Taira, Naha (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/200,161

(22) Filed: Jul. 23, 2002

(30) Foreign Application Priority Data
Jan. 25, 2002 (JP) 2002-017392

(51) Int. Cl. G06F 17/60

(52) U.S. Cl. 705/37

(57) ABSTRACT

A user purchases a commodity in a store, and transmits a home delivery request by a user terminal. A service center for receiving home delivery requests transmits IC tag information to the store or the like. In the store, the information is written in an IC tag, and the tag is attached to the commodity. The service center transmits a pickup instruction to a delivery company. The user repeats such shopping. The delivery company staff member goes to the store to pick up the commodity. When the pickup is completed, a pickup completion notice is transmitted to the service center. The user transmits a purchase completion instruction to the service center at the time of the end of shopping. In response to this, the service center transmits a packing instruction to the delivery company. The delivery company carries out packing in response to this, and when a fee is fixed, a fee notice is transmitted to the service center. Then, the delivery company carries out the delivery to the user's house, and when the delivery is completed, delivery completion is transmitted to the service center.

### TECHNICAL FIELD OF THE INVENTION

The present invention relates to an information processing technique for collectively delivering a plurality of articles.

### BACKGROUND OF THE INVENTION

When souvenirs or the like are purchased at a tourist resort, if the souvenirs or the like are successively purchased during sightseeing, it is necessary to move while the purchased souvenirs are held, and they become heavy and difficult to carry, or there occurs a case where although there is something desired to purchase, its purchase must be abandoned since it is impossible to carry them. Although there exists a home delivery agency in a tourist resort, which is used by residents living in the vicinity thereof, such a home delivery agency does not exist in everyplace, and it is necessary to take the time to look for the agency during the sightseeing. Alternatively, it is unknown where such agency is, and eventually, sightseeing must be done while the purchased souvenirs are held, so that it becomes impossible to satisfactorily enjoy the sightseeing.

Also in a tourist resort, there exist stores or the like (including tourist facilities, etc.) handling door-to-door parcel delivery of souvenirs or the like, however, many such stores premise that only souvenirs purchased in the stores are sent. Accordingly, in the case where purchases are made in different stores, a delivery fee is required on each occasion, and a burden on a tourist is large.

### SUMMARY OF THE INVENTION

An object of the invention is therefore to provide an information processing technique to make it possible to collectively deliver articles purchased in different stores.

According to a first aspect of the invention, a delivery information processing method comprises the steps of: receiving a delivery request to deliver a purchased commodity from a purchase store is received; and if a purchase completion instruction is received, transmitting to a delivery company, a packing instruction of purchased commodities meeting a predetermined condition among all purchased commodities relating to the delivery requests received by the reception of the purchase completion instruction.

By doing so, for example, when the user merely transmits the delivery request each time a commodity is purchased, and transmits the purchase completion instruction at the time of the end of shopping to a computer for carrying out this delivery information processing method, the purchased articles are collectively delivered, and accordingly, the convenience becomes high. Although a delivery company must collect and pack the respective articles, if many users request deliveries through this system, the profits are raised. Also for stores, since the user can purchase souvenirs or the like without giving consideration to carrying, the volume of sales is increased and the profits are raised.

Incidentally, the delivery information processing method according to the first aspect of the invention may further comprise a step of, if the purchase completion instruction is not received though a predetermined time has passed since the first delivery request was received, transmitting to the delivery company, a packing instruction of purchased commodities meeting the predetermined condition in all purchased commodities relating to the delivery requests received before elapse of the predetermined time. There is also a case where the user forgets to transmit the purchase completion instruction, and for convenience of management of purchased commodities picked up, the predetermined time is set, and processing is made on the assumption that the purchase completion instruction is automatically given.

Besides, the delivery information processing method according to the first aspect of the invention may further comprise a step of, if an extension request of the predetermined time is received, setting an extension of the predetermined time. This is for the user who does some shopping for a long time.

The delivery information processing method according to the first aspect of the invention may further comprise a step of, if the purchase completion instruction is not received though the predetermined time has passed since the first delivery request is received, notifying the user of a reception completion of the delivery request. This is because in the case where the purchase completion processing is automatically carried out, it is better to notify the user that the delivery request can not received any more.

Besides, the delivery information processing method according to the first aspect of the invention may further comprise a step of previously notifying the user of a receipt completion of the delivery request at a predetermined timing before the predetermined time passes. This is for causing the user to recognize a reception deadline of the delivery request.

Besides, the delivery information processing method according to the first aspect of the invention may further comprise a step of estimating a delivery fee using information concerning the delivery request in response to a request from the user terminal, and transmitting estimate information of the delivery fee to a user terminal. The user can adjust the delivery requests in view of the estimate of the delivery fee.

Further, the delivery information processing method according to the first aspect of the invention may further comprise a step of, if the delivery request to deliver the purchased commodity from the purchase store is received, transmitting a pickup instruction of the purchased commodity to a computer of the delivery company. It is also possible to transmit the pickup instruction each time the delivery request is received, or the delivery company staff member may periodically go to predetermined stores to pick up cargos even if the pickup instruction is not given.

Besides, the delivery information processing method according to the first aspect of the invention may further comprise a step of, if a predetermined number of or more delivery requests to deliver from a specific purchase store are received, transmitting to the delivery company, a pickup request of purchased commodities for the specific purchase store and a store related to the specific purchase store. By doing so, since pickup of a certain amount of cargos can be made, it becomes possible to make effective pickup.

Incidentally, it is possible that the packing instruction includes information concerning an address for delivery destination specified by the user. That is, in this configuration, the packing instruction also serves as a delivery instruction.

Further, the delivery information processing method according to the first aspect of the invention may further comprise a step of, if the delivery request to deliver the purchased commodity from the purchase store is received, transmitting information used for at least packing of the purchased commodity by the delivery company to the user terminal or a computer of the purchase store. For example, in the case where an IC tag is used for effectively and exactly carrying out the pickup or the packing, the information is, for example, user identification information to be written in the IC tag, or identification information (for example, representative number in the embodiments) of a purchased commodity group to be collectively delivered. The use of such information saves the user such trouble as writing an invoice.

Besides, there is also a case where the above described predetermined condition is that the purchase store is a store other than previously specified stores, or the purchased commodity is a commodity other than previously specified commodities. This is because it is impossible to carry out collective packing for a commodity purchased in a store outside of a predetermined pickup area or perishable foods requiring special handling.

According to a second aspect of the invention, a delivery information processing method comprises the steps of: receiving a delivery request to deliver a purchased commodity from a purchase store; after a predetermined timing (for example, after a predetermined time has passed since a first delivery request or at a predetermined time), transmitting to a delivery company, a packing instruction of purchased commodities meeting a predetermined condition among all purchased commodities relating to delivery requests received before the predetermined timing. As stated above, it is also possible to adopt a configuration on the premise that the user does not give a purchase completion instruction.

According to a third aspect of the invention, a delivery request processing method comprises the steps of: transmitting a delivery request of a purchased commodity including information concerning the purchased commodity and a purchase store to a center server for at least each purchase store; and transmitting to the center server, a request for start of collective delivery of purchased commodities satisfying a predetermined condition among all purchased commodities to a specified place.

Incidentally, the foregoing method can be carried out through a program and a computer, and this program is stored in a storage medium or a storage device, for example, a flexible disk, a CD-ROM, a magneto-optical disk, a semiconductor memory, or a hard disk. Besides, there is also a case where the program is distributed through a network or the like. Incidentally, intermediate processing results are temporarily held in a memory.

### BRIEF DESCRIPTION OF THE DRAWINGS

FIG. 1 is a drawing showing a business flow according to one embodiment of the invention;

FIG. 2 is a drawing showing a system configuration example according to the one embodiment of the invention;

FIG. 3 is a drawing showing an example of data stored in a user master DB;

FIG. 4 is a drawing showing an example of data stored in a store master DB;

FIG. 5 is a drawing showing an example of data stored in a representative number management table;

FIG. 6 is a drawing showing an example of data stored in a home delivery request reception table;

FIG. 7 is a drawing showing an example of data stored in a pickup management table;

FIG. 8 is a drawing showing an example of data stored in a delivery management table;

FIG. 9 is a drawing showing an example of data stored in a packing estimate table;

FIG. 10 is a drawing showing an example of data stored in a special article delivery fee table;

FIG. 11 is a drawing showing an example of data stored in a point DB;

FIG. 12 is a drawing showing a first portion of the whole processing flow according to the one embodiment of the invention;

FIG. 13 is a drawing showing an example of a page for a home delivery request;

FIG. 14 is a drawing showing a second portion of the whole processing flow according to the one embodiment of the invention;

FIG. 15 is a drawing showing a processing flow of a processing for receiving the home delivery request;

FIG. 16 is a drawing showing an example of a page for indicating the reception of the home delivery request;

FIG. 17 is a drawing showing a processing flow of a delivery fee estimate processing;

FIG. 18 is a drawing showing a processing flow of a purchase deadline warning processing;

FIG. 19 is a drawing showing a processing flow of a purchase completion instruction processing;

FIG. 20 is a drawing showing an example of a purchase completion instruction page;

FIG. 21 is a drawing showing an example of a page for confirming the home delivery request reception;

FIG. 22 is a drawing showing an example of packing instruction data;

FIG. 23 is a drawing showing a processing flow of a correction instruction processing of a home delivery request;

FIG. 24 is a drawing showing a processing flow of a purchase deadline excess processing;

FIG. 25 is a drawing showing a processing flow of a packing instruction processing;

FIG. 26 is a drawing showing a processing flow of a processing to confirm a home delivery request reception;

FIG. 27 is a drawing showing a processing flow of a processing to confirm a home delivery request reception after a purchase deadline expires;

FIG. 28 is a drawing showing a processing flow of a purchase deadline extension processing; and

FIG. 29 is a drawing showing a processing flow of a pickup instruction processing.

### DETAIL DESCRIPTION OF THE PREFERRED EMBODIMENTS

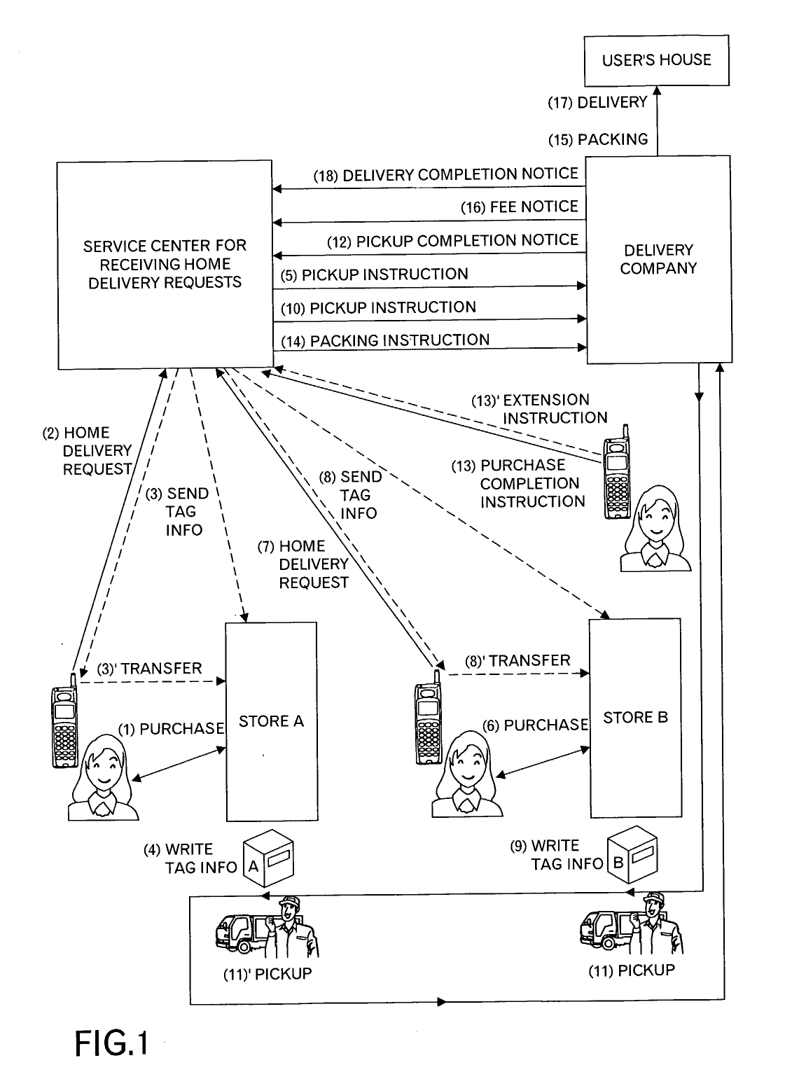

First, an example of a business flow according to one embodiment of the present invention will be described with reference to FIG. 1. A user purchases, for example, a commodity A in a store A (step (1)). At that time, the user uses, for example, a cellular phone to transmit a home delivery request including information of a user ID, the store A, identification information and commodity size of the commodity A, and the like to a service center for receiving home delivery requests (step (2)). When receiving the home delivery request, a center server of the service center for receiving home delivery requests generates IC tag information including a reception number, which is a combination of a representative number for specifying collectively delivered commodities, and addition number for identifying the respective commodities, and user information such as a user ID, and transmits it to the cellular phone of the user or an IC tag writer installed in the store A (step (3)). In the case where the IC tag information is transmitted to the cellular phone of the user, the IC tag information is transmitted from the cellular phone by communication means such as Bluetooth, wireless LAN, infra-red communication or cable connection to the IC tag writer of the store A (step (3)′). In the store A, the received information is written by the IC tag writer into an IC tag (step (4)), and it is attached to the commodity A or a package of the commodity A. A slip may be printed using the IC tag information and may be attached to the commodity A or the like. Incidentally, the home delivery request is not transmitted from the cellular phone of the user, but may be transmitted from an equipment such as a POS register of the store A to the center server of the service center for receiving home delivery requests. The center server of the service center for receiving home delivery requests transmits a pickup instruction of the commodity A from the store A to a server of a delivery company (step (5)). Incidentally, an estimate result of a delivery fee is transmitted from the center server of the service center for receiving home delivery requests to the cellular phone of the user.

The user next visits a store B and purchases a commodity B (step (6)). At that time, the user uses, for example, the cellular phone to transmit a home delivery request including information of the user ID, a store B, identification information and commodity size of the commodity B, and the like to the service center for receiving home delivery requests (step (7)). When receiving the home delivery request, the center server of the service center for receiving home delivery requests generates IC tag information including a reception number, user information such as the user ID, and transmits it to the cellular phone of the user or an IC tag writer installed in the store B (step (8)). In the case where the IC tag information is transmitted to the cellular phone of the user, the IC tag information is transmitted from the cellular phone by some communication means to the IC tag writer of the store B (step (8)′). In the store B, the received information is written by the IC tag writer into an IC tag (step (9)), and it is attached to the commodity B or a package of the commodity B. A slip may be printed using the IC tag information and may be attached to the commodity B or the like. The center server of the service center for receiving home delivery requests transmits a pickup instruction of the commodity B from the store B to the server of the delivery company (step (10)). Besides, an estimate result of a delivery fee is transmitted from the center server of the service center for receiving home delivery requests to the cellular phone of the user.

The delivery company picks up the commodity A with the IC tag from the store A, and the commodity B from the store B (step (11) and (11)′). The delivery company transmits a pickup completion notice including the reception numbers and the like of the picked-up commodities from the server of the delivery company to the center server of the service center for receiving home delivery requests (step (12)).

In the case where such processing is repeated and the user decides to end shopping, the user uses, for example, the cellular phone to transmit a purchase completion instruction including the user ID to the center server of the service center for receiving home delivery requests (step (13)). When receiving the purchase completion instruction, the center server of the service center for receiving home delivery requests transmits a packing instruction to the server of the delivery company (step (14)). When the server of the delivery company receives the packing instruction, the delivery company uses the IC tags attached to the commodities to collect a commodity group to be collectively delivered and does some packing (step (15)). The information of the address for delivery destination, the information of the commodity group to be packed, and the like are included in the packing instruction and is used for packing and delivery. Since a delivery fee is fixed at the time of packing, the delivery company inputs the information of the fixed delivery fee to the server of the delivery company, and the server of the delivery company transmits a fee notice including the representative number and the fixed delivery fee to the center server of the service center for receiving home delivery requests (step (16)). The center server of the service center for receiving home delivery requests may notify the cellular phone of the user of the fixed delivery fee.

Then, the delivery company delivers the packed commodity group to a specified place such as user's house (step (17)). When the delivery is completed, delivery completion is registered in the server of the delivery company, and a delivery completion notice is transmitted from the server of the delivery company to the center server of the service center for receiving home delivery requests (step (18)).

By doing so, even in the case where the user makes a round of a plurality of stores and does the shopping, it is not necessary to carry the purchased commodities, and the burden for an sightseeing is reduced. Although the delivery company takes trouble of pickup and packing, since the convenience is high for the user, it is expected that the use of home delivery service is increased, and the profits are increased. Further, for the store, since shopping can be done without regard to carrying, it is expected that the amount of purchase by the user is increased and the profits are increased.

Incidentally, the delivery fee can be paid on delivery, or may be performed through a credit card or a bank account registered in the service center for receiving home delivery requests. Besides, although FIG. 1 shows the example in which the user gives the purchase completion instruction, in the case where the purchase completion instruction is not given within a predetermined time since the home delivery request made at the time of the purchase of the commodity A, a judgment of purchase completion may be automatically made and the step (14) and the processing subsequent to the step (14) may be carried out. However, according to circumstances of shopping of the user, there is also a case where an extension instruction is transmitted from the cellular phone of the user to the center server of the service center for receiving home delivery requests (step (13)′). The center server of the service center for receiving home delivery requests, which receives the extension instruction, extends the deadline time by a predetermined time.

Incidentally, the user can acquire the status of the home delivery request from the center server of the service center for receiving home delivery requests by the cellular phone or the like. Besides, there is also a case where points are given to the store and the user using this system to facilitate the use.

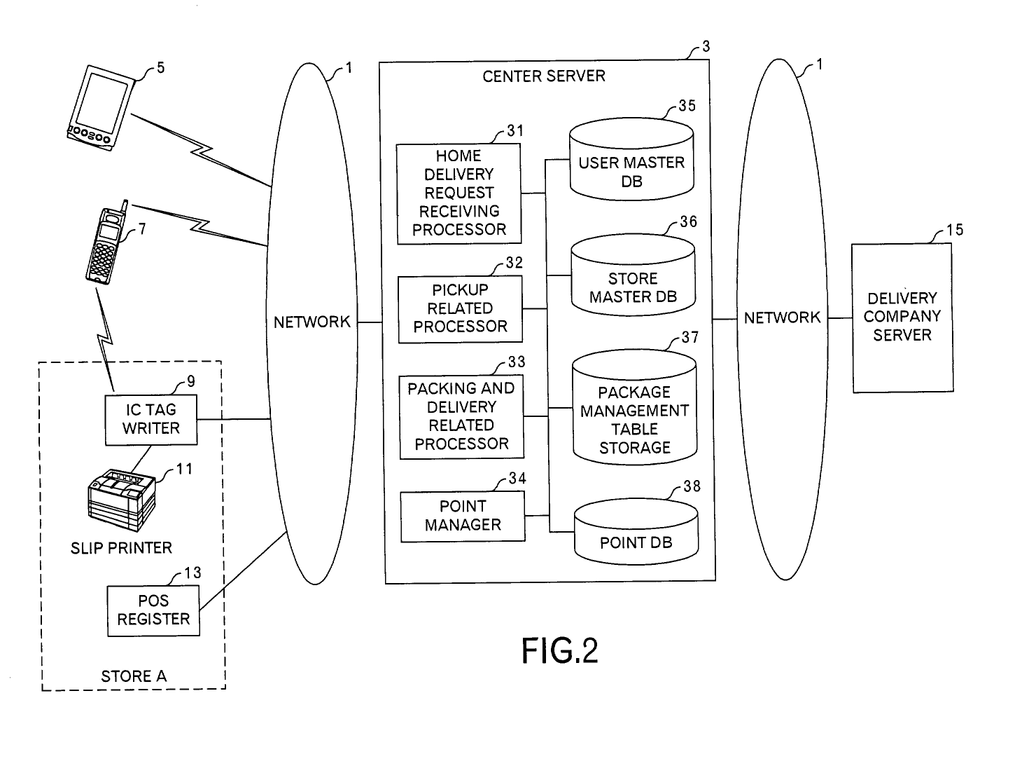

Next, an example of a computer system used for carrying out the business flow as shown in FIG. 1 is shown in FIG. 2. A center server 3 installed in the service center for receiving home delivery requests is connected to a network 1 such as the Internet. A user terminal such as a PDA (Personal Digital Assistance) 5 or a cellular phone 7, an IC tag writer 9 and a POS register 13 installed in a store, for example, a store A, a delivery company server 15 installed in the facilities of a delivery company are connected to the network 1. A slip printer 11 is connected to the IC tag writer 9.

Incidentally, if the IC tag writer 9 installed in the store and the user terminal such as the cellular phone 7 can be communicated with each other through Bluetooth (for more details, see http://www.bluetooth.com), wireless LAN, cable connection or the like, the IC tag writer 9 may not be connected to the network 1. Besides, also with respect to the POS register 13, in the case where the home delivery request is transmitted to the center server 3 by the user terminal such as the cellular phone 7, it may not be connected to the network 1.

The IC tag writer 9, the POS register 13, and the delivery company server 15 may be connected to the center server 3 through a network different from the network used by the user, such as a private line.

The center server 3 includes a home delivery request receiving processor 31 for receiving and processing a home delivery request from the user terminal such as the cellular phone 7 or the POS register 13, a pickup related processor 32 for carrying out a processing associated with the pickup of articles relating to the home delivery request, a packing and delivery related processor 33 for carrying out a processing associated with packing and delivery in the delivery company on and after the purchase completion instruction or automatic purchase completion, and a point manager 34 for managing points given to users and stores. The center server 3 manages a user master DB 35 for storing personal information concerning users, a store master DB 36 for storing information concerning stores, a package management table storage 37 for storing a table for managing packages to be handled in this system, and a point DB 38 for storing information concerning points given to the users and stores.

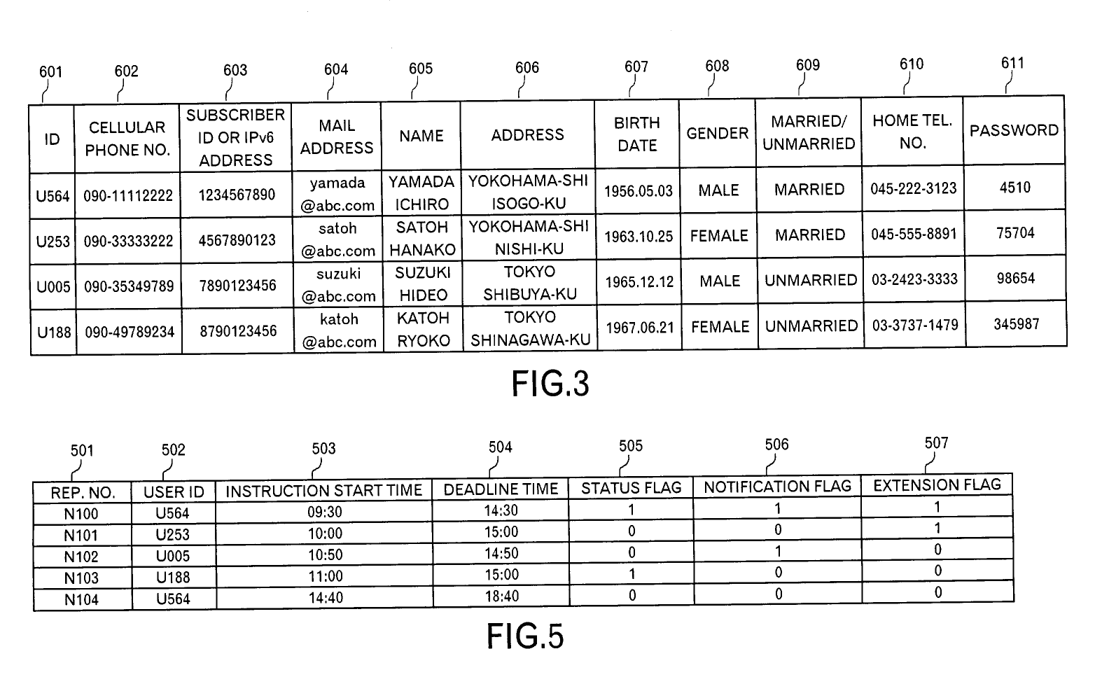

Next, an example of data stored in the user master DB 35 is shown in FIG. 3. The example of FIG. 3 includes a column 601 of a user ID, a column 602 of a cellular phone number of a user, a column 603 of a subscriber ID or an address of IPv6, used for identifying respective cellular phones, a column 604 of a mail address of a user, a column 605 of a name of a user, a column 606 of an address of a user, a column 607 of user's birth date, a column 608 of user's gender, a column 609 for storing information indicating a marriage status of a user, a column 610 of a home telephone number of a user, and a column 611 of a password used by a user. It is possible to include more personal attributes. There is also a case where information for payment is stored.

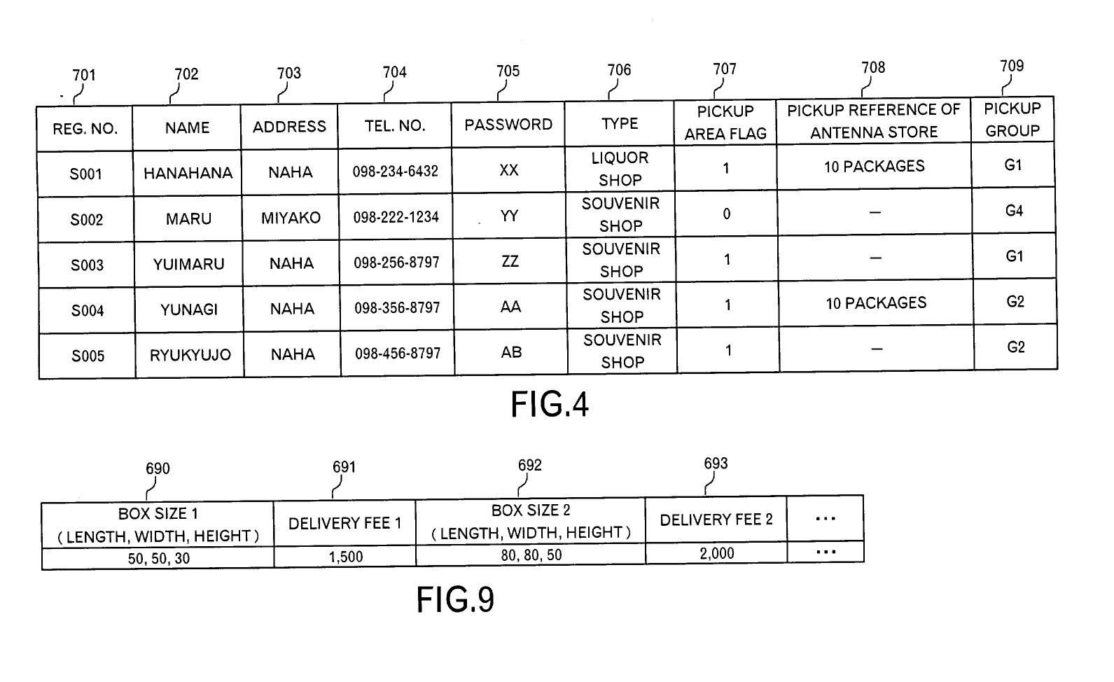

An example of data stored in the store master DB 36 is shown in FIG. 4. The example of FIG. 4 includes a column 701 of a registration number of a store, a column 702 of a name of a store or the like, a column 703 of an address of a store, a column 704 of a telephone number of a store, a column 705 of a password used by a store, a column 706 of classification of a store, a column 707 of a pickup area flag (“1” designates a normal pickup area: “0”, outside of the normal pickup area) used for, in a case where a store is situated at a place, such as a solitary island, outside a normal pickup area of a delivery company, performing special handling in pickup and delivery of a purchased commodity or in estimate of a delivery fee, a column 708 of a pickup reference concerning the number of articles to be picked up in an antenna store as a reference store when a pickup request is outputted to the delivery company, and a column 709 of a pickup group indicating a group of stores in which pickup should be made together in a case where there are more articles to be picked up than the pickup reference of the antenna store. It is possible that more store attributes are stored.

The table stored in the package management table storage 37 includes a representative number management table, a home delivery request reception table, a pickup management table, and a delivery management table. Incidentally, as auxiliary data, a packing estimate table and a special article delivery fee table are also stored.

An example of the representative number management table stored in the package management table storage 37 is shown in FIG. 5. The representative number is identification information for identifying groups of commodities collectively delivered. The example of FIG. 5 includes a column 501 of a representative number, a column 502 of a user ID of a user as a home delivery requester relating to the representative number, a column 503 of an instruction start time of a home delivery request, a column 504 of a purchase deadline time, a column 505 of a status flag indicating whether or not purchase is completed, a column 506 of a notification flag indicating whether or not a warning of the deadline time is given to a user before the purchase deadline time, and a column 507 of an extension flag indicating whether or not an extension of the purchase deadline time is performed.

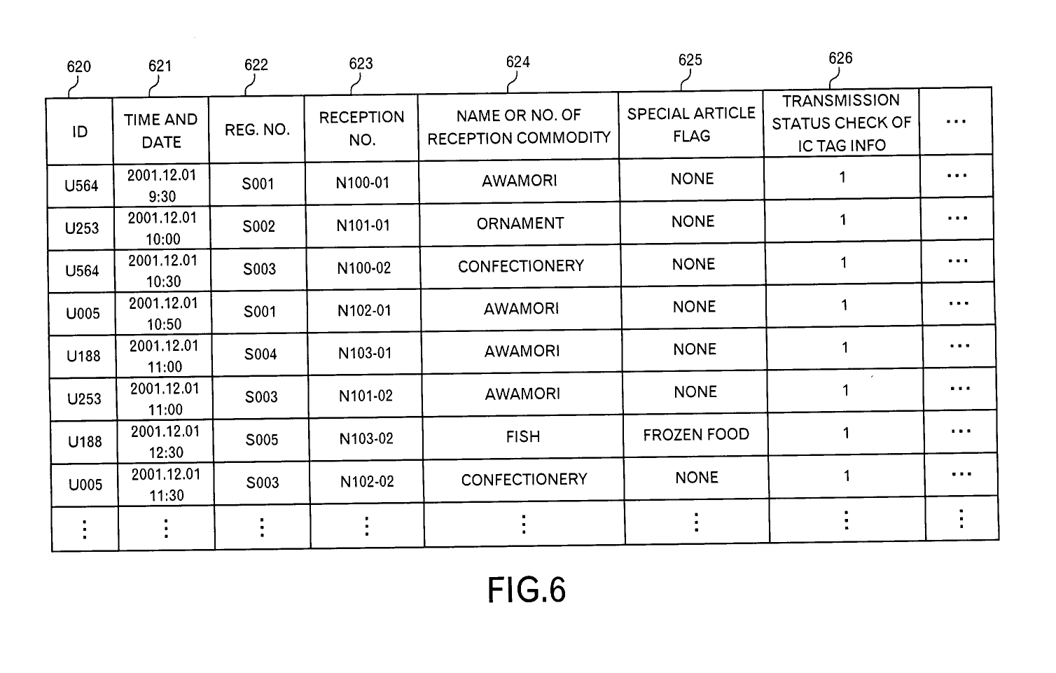

An example of the home delivery request reception table stored in the package management table storage 37 is shown in FIG. 6. The example of FIG. 6 includes a column 620 of a user ID of a user, who sent a home delivery request, a column 621 of a time and a date of reception of the home delivery request, a column 622 of a registration number of a store or the like in which the user purchased a commodity, a column 623 of a reception number constituted by a representative number (for example, N100) and a serial number (addition number: for example, 01) of the purchased commodity, a column 624 of a commodity name or a number of an objective commodity of the home delivery request, a column 625 of a special article flag indicating whether or not an objective commodity of the home delivery request is a special article, and a column 626 of transmission status check of the IC tag information (“1” denotes transmission completion: “0”, non-transmission) indicating whether or not IC tag information is transmitted. Although a commodity size storage column is not shown in FIG. 6, it is assumed that the column is stored in this table.

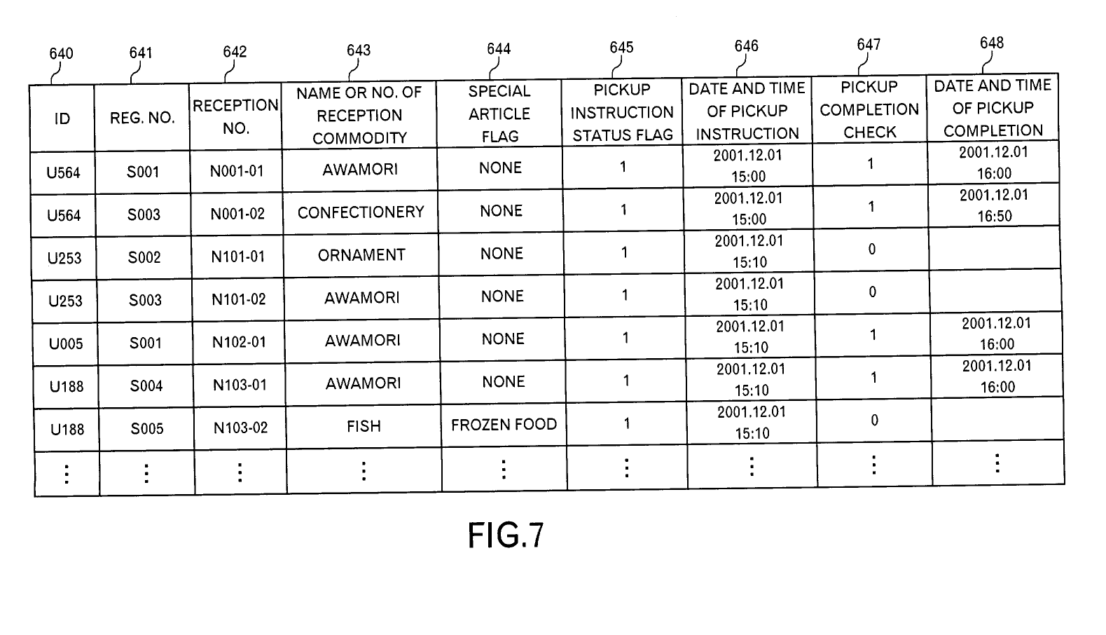

An example of the pickup management table stored in the package management table storage 37 is shown in FIG. 7. The example of FIG. 7 includes a column 640 of a user ID of a user, who sent a home delivery request, a column 641 of a registration number of a store or the like in which the user purchased a commodity, a column 642 of a reception number, a column 643 of a commodity name or a number of an objective commodity of the home delivery request, a column 644 of a special article flag indicating whether or not the objective commodity of the home delivery request is a special article, a column 645 of pickup instruction status check (“1” denotes completion of instruction: “0”, incompletion of instruction) indicating whether or not a pickup instruction is given to a delivery company, a column 646 of a date and a time of the pickup instruction, a column 647 of pickup completion check (“1” denotes completion of reception: “0”, incompletion of reception) indicating whether or not a pickup completion notice is received from the delivery company, and a column 648 of a date and time of the pickup completion.

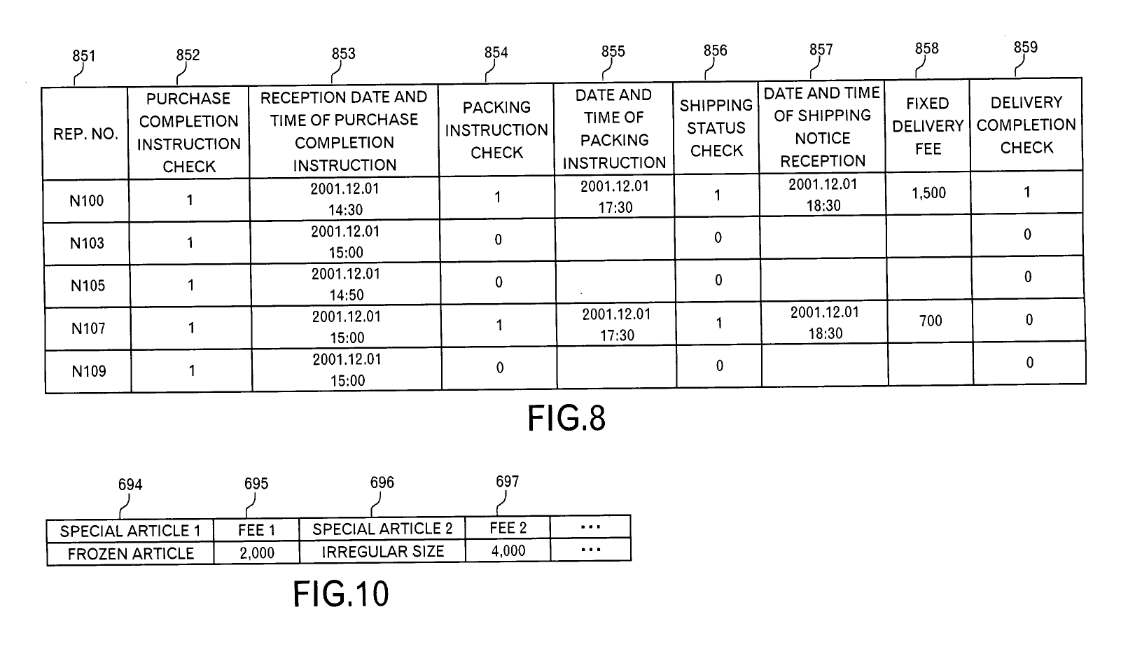

An example of the delivery management table stored in the package management table storage 37 is shown in FIG. 8. The example of FIG. 8 includes a column 851 of a representative number, a column 852 of a purchase completion instruction check (“1” denotes it has been received: “0”, it has not been received) indicating whether or not a purchase completion instruction is received from the user, a column 853 of a reception date and time of the purchase completion instruction, a column 854 of packing instruction check (“1” denotes it has been transmitted: “0”, it has not been transmitted) indicating whether or not a packing instruction is transmitted to a delivery company, a column 855 of a date and a time of the packing instruction, a column 856 of shipping status check indicating whether or not a shipping notice of a packed article is received from the delivery company, a column 857 of a date and time of the shipping notice reception, a column 858 of a fixed delivery fee included in the shipping notice, and a column 859 of delivery completion check (“1” denotes it has been received: “0”, it has not been received) indicating whether or not a delivery completion notice is received from the delivery company server 15.

An example of the packing estimate table stored in the package management table storage 37 is shown in FIG. 9. The example of FIG. 9 includes a column 690 of box size 1 (length, width, height), a column 691 of a delivery fee 1 for the box size 1, a column 692 of a box size 2 (length, width, height), a column 693 of a delivery fee 2 for the box size 2, Here, all kinds of boxes used for packing of plural purchased commodities are defined.

An example of the special article delivery fee table stored in the package management table storage 37 is shown in FIG. 10. The example includes a column 694 of a special article 1 for storing name of a first special article, a column 695 of a fee 1 for storing a delivery fee of the special article 1, a column 696 of a special article 2 for storing a name of a second special article, and a column 697 of a fee 2 for storing a delivery fee of the special article 2. With respect to a frozen commodity and a commodity of irregular size as shown in FIG. 10, they are not packed together with other purchased commodities, and the delivery fee of the special article delivery fee table is applied as it is.

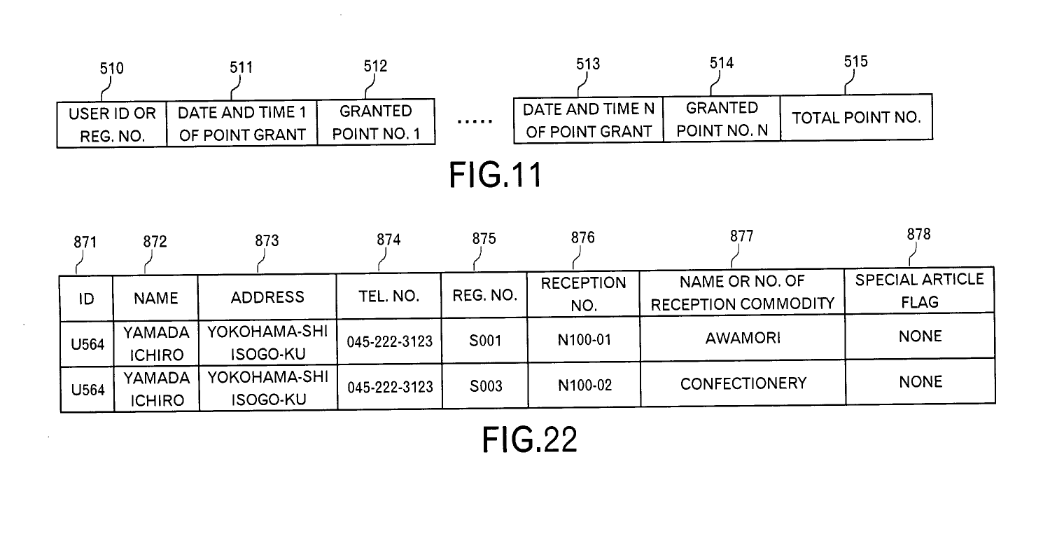

An example of a data structure stored in the point DB 38 is shown in FIG. 11. The example of FIG. 11 includes a column 510 of a user ID in the case of a user or a registration number in the case of a store, a column 511 of a date and time 1 when a point is granted, a column 512 of granted point number 1 on a date and time 1, . . . , a column 513 of a date and time n when a point is granted, a column 514 of granted point number n on a date and time n, and a column 515 of the total point number for the user ID or the registration number.

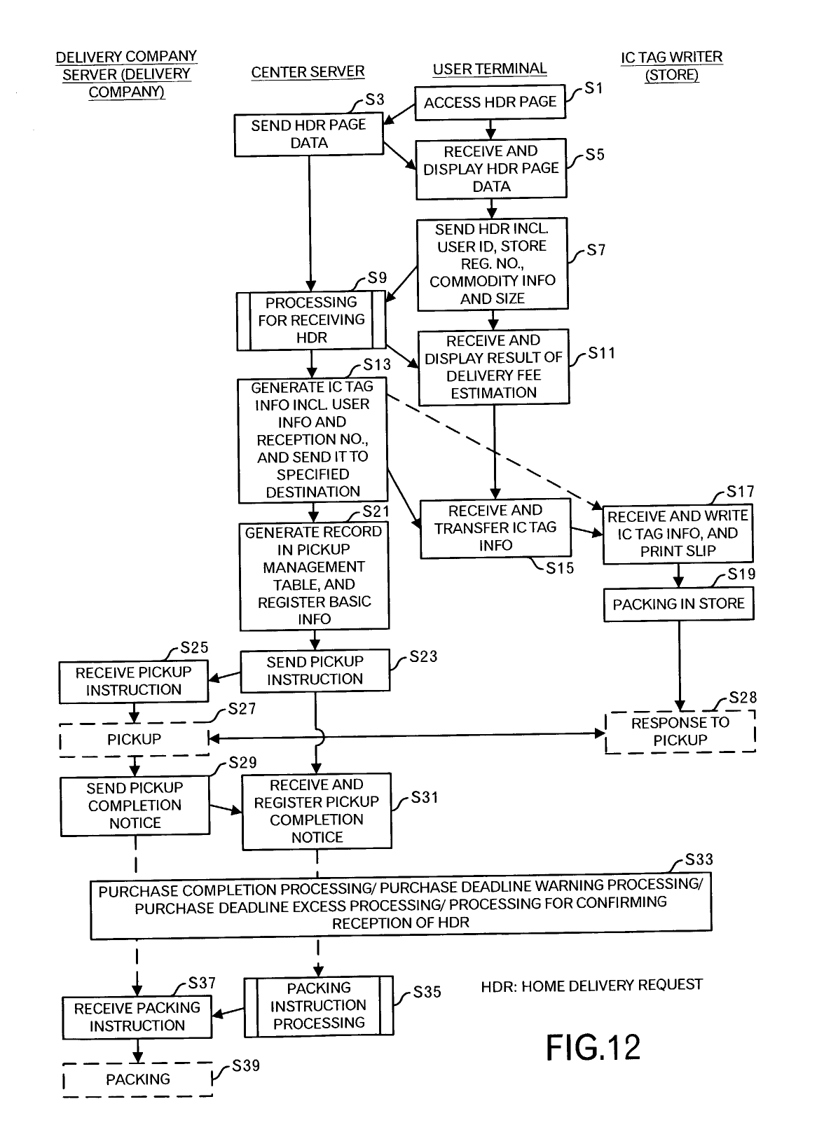

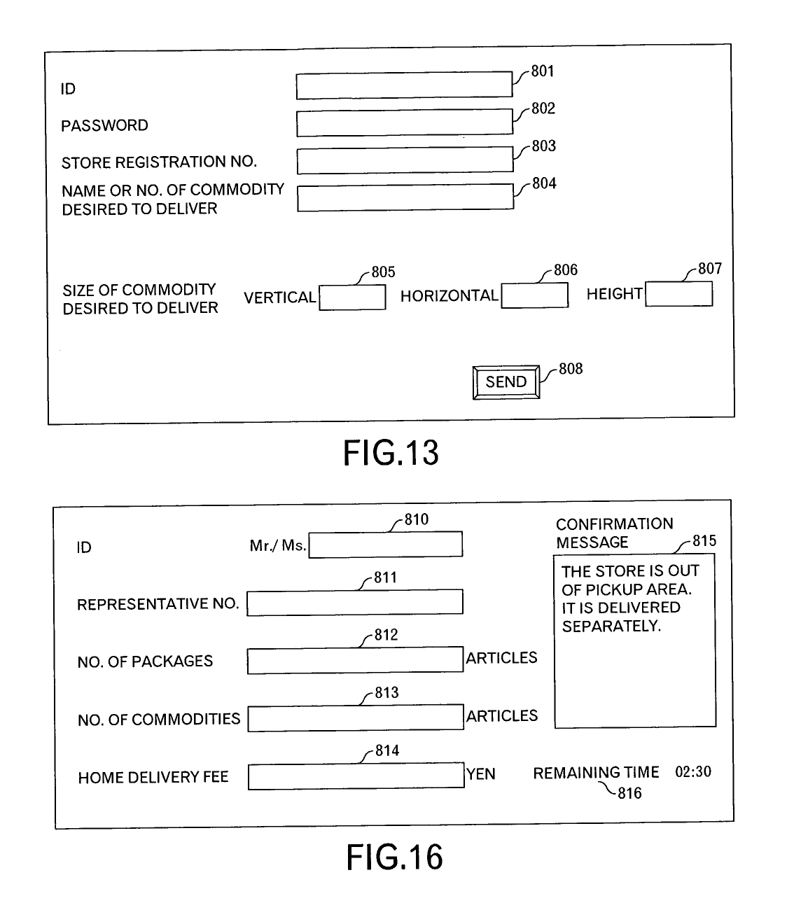

Hereinafter, a processing flow of the system shown in FIG. 2 will be described with reference to FIGS. 12 to 29. First, the outline of the processing will be described with reference to FIG. 12. It is assumed that a user decides to purchase a commodity in a store and to use this service. Then, the user operates a user terminal such as the cellular phone 7 to access a home delivery request page provided by the center server 3 (step S1). In response to the access from the user terminal, the home delivery request receiving processor 31 of the center server 3 transmits page data for a home delivery request (step S3). The user terminal receives the page data for the home delivery request from the center server 3, and displays it on a display device by a Web browser or the like (step S5). For example, a screen as shown in FIG. 13 is displayed. Although FIG. 13 premises a relatively large screen size, in the case of the cellular phone 7, the screen shown in FIG. 3 may be divided into plural screens, and each screen may be separately displayed. The example of FIG. 13 includes an input column 801 of a user ID, an input column 802 of a password, an input column 803 of a registration number of a store in which a commodity is purchased, an input column 804 of a commodity name or a commodity number of a commodity desired to deliver to home, a vertical size input column 805 of a commodity desired to deliver to home, a horizontal size input column 806, a height size input column 807, and a send button 808. Incidentally, in the case where the kind of the commodity is specified to a certain degree, a commodity master DB registering information of sizes corresponding to commodity names or commodity numbers is provided in the center server 3, and not the size input of the user, but the data of the commodity master DB may be used.

The user inputs data to the respective input columns and clicks the send button 808. Then, the user terminal transmits a home delivery request including the inputted user ID, the password, the registration number of the store, and the commodity information such as the commodity name or commodity number, and the size to the center server 3 (step S7). When receiving the foregoing home delivery request from the user terminal, the home delivery request receiving processor 31 of the center server 3 carries out an authentication processing and a processing for receiving the home delivery request by using the received user ID, the password, and the data of the user master DB 35 (step S9). The processing for receiving the home delivery request will be described later in detail. The home delivery request receiving processor 31 of the center server 3 generates page data for indicating the reception of the home delivery request, which includes a delivery fee estimate result, and transmits it to the user terminal. The user terminal receives the page data for indicating the reception of the home delivery request, including the delivery fee estimate result from the center server 3 and displays it on the display device (step S11).

The home delivery request receiving processor 31 of the center server 3 uses information stored in the user master DB 35 to generate IC tag information including user information such as the user ID, a reception number including a representative number and addition number, and the like, determines a transmission destination, and transmits the IC tag information (step S13). The transmission destination is, for example, the user terminal such as the cellular phone 7 or the IC tag writer 9 installed in the store. This determination is based on whether the IC tag writer 9 is connected to the network 1, or whether the user terminal and the IC tag writer 9 can be communicated with each other. Incidentally, it may be fixedly transmitted to the user terminal or the IC tag writer 9. In the case where the user terminal receives the IC tag information from the center server 3, the IC tag information is transferred to the IC tag writer 9 (step S15). When receiving the IC tag information from the center server 3 or the user terminal, the IC tag writer 9 temporarily stores it into the storage device, and writes the IC tag information into the IC tag set in the IC tag writer 9. Besides, a delivery slip is printed by the slip printer 11 connected to the IC tag writer 9 (step S17). The information included in the user information, such as the address, is printed on the delivery slip. Three delivery slips are printed, and one is a copy for the user; another, a copy for the store; and the other, a copy for the delivery company.

A staff member of the store carries out packing in the store, for example, attaches the written IC tag to the purchased commodity of the user or its package, and/or sticks the printed delivery slip (step S19).

Besides, the pickup related processor 32 of the center server 3 newly generates a record of the pickup management table shown in FIG. 7, and registers the basic information such as the user ID, registration number, reception number, commodity name or commodity number relating to the home delivery request, setting of a special article flag, pickup instruction status check, and the date and time of the pickup instruction (step S21). Then, the pickup instruction including the user ID, the registration number, the reception number and the like is sent to the delivery company server 15 (step S23). The delivery company server 15 receives the pickup instruction including the user ID, the registration number, the reception number, and the like from center server 3, and stores it into the storage device (step S25). The delivery company uses the information of the received pickup instruction to carry out the pickup for the store (step S27). Incidentally, the pickup may not be carried out in accordance with the pickup instruction. That is, when the store is placed on a normal pickup route of the delivery company, the pickup may be made on the pickup route. Even in such a case, since it is necessary to carry out packing later, the information of the pickup instruction is registered in the storage device, and can be used for packing preparation after the pickup. Besides, the pickup may not be immediately carried out in accordance with the pickup instruction. Incidentally, with respect to the pickup, another embodiment will be described later.

When the pickup is completed, the delivery company registers pickup completion in the delivery company server 15 by reading out the IC tag information from the IC tag and the like. Then, the delivery company server 15 transmits the pickup completion notice including the reception number and the like included in the IC tag information to the center server 3 (step S29). When receiving the pickup completion notice including the reception number and the like from the delivery company server 15, the pickup related processor 32 of the center server 3 sets “1” in the column 647 of the pickup completion check of the pickup management table (FIG. 7), and registers the date and time of the reception of the pickup completion notice in the column 648 of the date and time of the pickup completion (step S31).

Thereafter, a purchase completion processing, a purchase deadline warning processing, a purchase deadline excess processing, and a processing for confirming the reception of the home delivery request are carried out. These processings will be described later in detail.

Thereafter, the packing and delivery related processor 33 of the center server 3 carries out the packing instruction processing, generates information of the packing instruction including the user information and the information of the reception number and the like, and transmits it to the delivery company server 15 (step S35). Incidentally, in the packing instruction processing, “1” is set in the column 854 of the packing instruction check of the delivery management table (FIG. 8), and the date and time when the packing instruction is transmitted is registered in the column 855 of the date and time of the packing instruction. The packing instruction processing will be described later in detail. The delivery company server 15 receives the packing instruction information including the user information and the information such as the reception number, and stores it in the storage device (step S37). Then, the delivery company uses the information of the packing instruction and the information written in the IC tag included in the purchased commodity to carry out packing of the purchased commodities (step S39). Incidentally, in this embodiment, the packing instruction includes the meaning of the delivery instruction. However, such a configuration may be adopted that both are separately instructed.

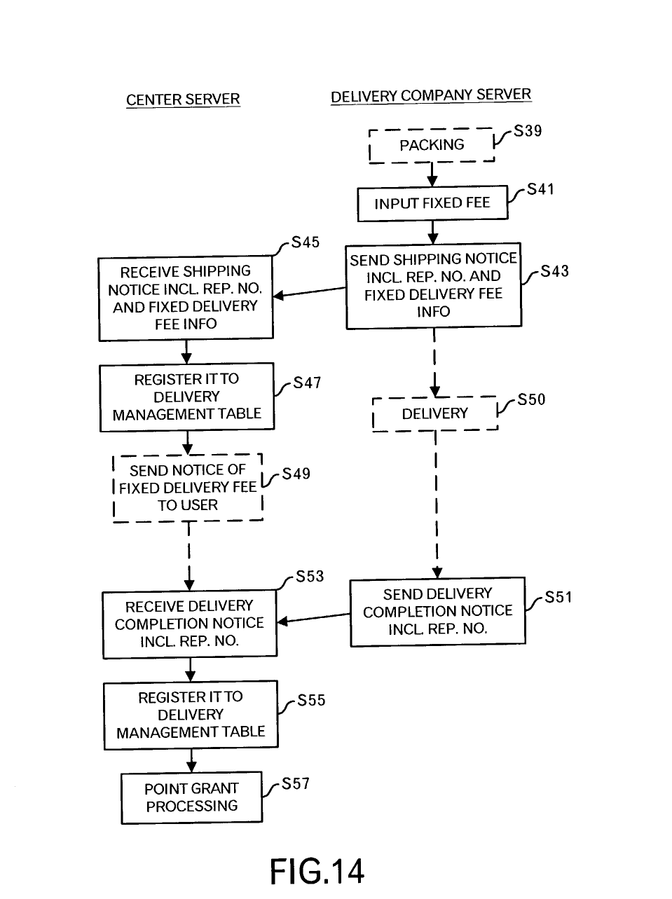

A subsequent processing proceeds to FIG. 14. When packing is made (step S39), since a delivery fee is fixed, the delivery company inputs the fixed delivery fee to the delivery company server 15, and stores it in the storage device (step S41). Besides, a shipping notice including the representative number and the fixed delivery fee information is transmitted to the center server 3 (step S43). The delivery company delivers a packed article to the place specified by the user (step S50).

The packing and delivery related processor 33 of the center server 15 receives the shipping notice including the representative number and the fixed delivery fee information (step S45), sets “1” in the column 856 of the shipping status check of the delivery management table (FIG. 8), registers the date and time of the shipping notice reception in the column 857 of the date and time of the shipping notice reception, and registered information of the fixed delivery fee in the column 858 of the fixed delivery fee (step S47). At this point, a notice of the fixed delivery fee may be sent to the user by, for example, e-mail (step S49).

When the delivery is completed, the delivery company inputs information such as the representative number and the delivery completion date to the delivery company server 15. Then, the delivery company server 15 stores the information into the storage device. Then, the delivery company server 15 generates the delivery completion notice including the representative number and transmits it to the center server 3 (step S51). When receiving the delivery completion notice including the representative number from the delivery company server 15 (step S53), the packing and delivery related processor 33 of the center server 3 sets “1” in the column 859 of the delivery completion check of the delivery management table (step S55).

Thereafter, the point manager 34 reads out the record in which “1” is set in the column 859 of the delivery completion check of the delivery management table (FIG. 8) to acquires the representative number, acquires the corresponding user ID and registration number from the home delivery request reception table (FIG. 6), and gives predetermined points to the user of the user ID and the store of the registration number (step S57). As to the point, in accordance with the data structure of the point DB 38 shown in FIG. 11, the date and time of the point grant, and granted point value are registered, and the total point value is again calculated and is registered.

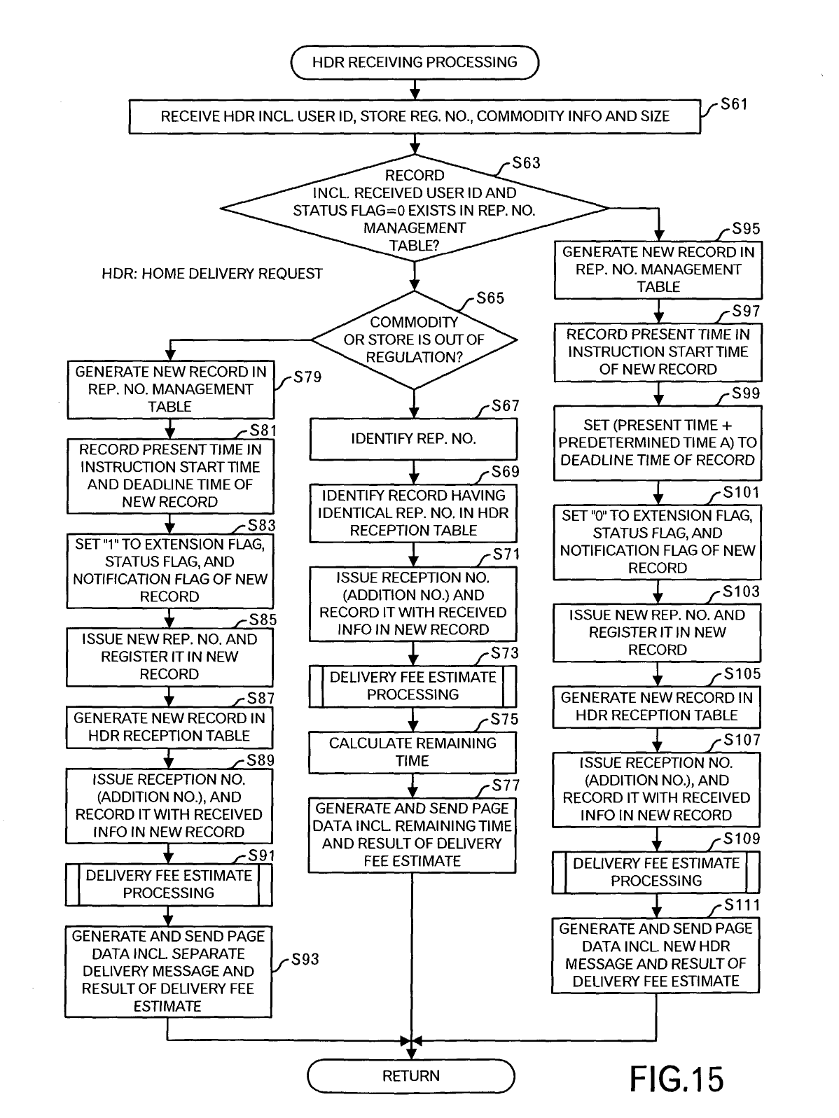

A detailed processing flow of the processing for receiving the home delivery request will be described with reference to FIGS. 15 to 17. The home delivery request receiving processor 31 of the center server 3 receives the home delivery request including the user ID, the registration number of the store, the commodity information, the size, and the like from the user terminal (step S61). In the case where the user inputs the information to the screen as shown in FIG. 13 and the user terminal transmits the input information, since the ID and the password are included in the home delivery request, the information stored in the user master DB 35 is used here to carry out the authentication processing. Here, it is assumed that the authentication processing is successfully completed.

The home delivery request receiving processor 31 uses the user ID included in the home delivery request to search the representative number management table (FIG. 5), and looks for a record in which the user ID is registered and the status flag is “0” (which means not in purchase completion state) (step S63). In case the record including the user ID and the status flag=0 is not found, it is judged that the home delivery request is a first one, and generates a new record in the representative number management table (FIG. 5) (step S95). Then, the present time is recorded in the column 503 of the instruction start time of the new record (step S97). Besides, the deadline time of the new record is set to ((the present time)+(a predetermined time A (for example, 4 hours))), and is recorded in the column 504 of the purchase deadline time (step S99). Further, all of the extension flag of the new record, the notification flag, and the status flag are set to “0”, and are recorded in the respective columns of the representative number management table (FIG. 5) (step S101) Further, a new representative number is issued, and is recorded in the column 501 of the representative number of the new record (step S103). Further, a new record is generated in the home delivery request reception table (FIG. 6) (step S105), a reception number (addition number) is issued, and is recorded in the new record, together with the information (user ID, reception date and time, registration number, objective commodity name or number, special article flag, etc.) received from the user terminal (step S107). Then, the delivery fee estimate processing is carried out (step S109). This delivery fee estimate processing will be described later. Then, page data for indicating the reception of the home delivery request, including the result of the delivery fee estimate, which is generated by the delivery fee estimate processing, and a new home delivery request reception message is generated and is transmitted to the user terminal (step S111).

A screen example of the page for indicating the reception of the home delivery request is shown in FIG. 16. The example of FIG. 16 includes a display column 810 of a user ID, a display column 811 of a representative number, a display column 812 of the number of items to be packed, a display column 813 of the number of home delivery commodities, a display column 814 of a home delivery fee (delivery fee), a display column 815 of a confirmation message, and a remaining time display part 816. As a new home delivery reception message, in the display column 815 of the confirmation message, for example, such a message as “Home delivery request is newly received” is included. Incidentally, FIG. 16 shows such a message example as “The store exceeds a pickup area. This is delivered separately.” On the other hand, in the case where it is judged that there is a record having the received user ID and the status flag=0 in the representative number table (FIG. 5), it is confirmed that an additional home delivery request is made. Next, it is judged whether the commodity relating to this home delivery request is a commodity not satisfying a packaging standard, such as a special article, or the commodity purchase store is positioned outside a normal pickup area (whether the pickup area flag 707 of the store in the store master DB 36 (FIG. 4) is “0”) (step S65).

In case the home delivery request relating to the commodity not satisfying the packaging standard, such as the special article, is made, an individual delivery is separately made here. The same applies to the case where the store is positioned outside the normal pickup area. Accordingly, a new record is generated in the representative number management table (FIG. 5) (step S79), and the present time is recorded in the column 503 of the instruction start time of the new record and the column 504 of the deadline time (step S81). Further, all of the extension flag, the notification flag, and the status flag of the new record are set to “1”, and the value is recorded in the respective columns of the representative number management table (FIG. 5) (step S83). Further, a new representative number is issued and is recorded in the column 501 of the representative number of the new record (step S85). Further, a new record is generated in the home delivery request reception table (FIG. 6) (step S87), a reception number (addition number) is issued and is recorded in the new record, together with the information (user ID, reception date and time, registration number, objective commodity or number, special article flag, etc.) received from the user terminal (step S89). Then, the delivery fee estimate processing is carried out (step S91). This delivery fee estimate processing will be described later. Then, page data for indicating the reception of the home delivery request including a delivery fee estimate result, which is generated by the delivery fee estimate processing, and a message indicating separate delivery is generated, and is transmitted to the user terminal (step S93). The message indicating separate delivery is such a message as “The store exceeds a pickup area. This is delivered separately.” or “This is a special article. This is delivered separately.”, as shown in FIG. 16.

Incidentally, this embodiment has such a configuration that in the case where the commodity relating to the home delivery request is a special article, or the purchase store of the commodity is positioned outside the normal pickup, this causes a separate delivery. However, the invention is not limited to this, and such a configuration may be adopted that for example, frozen commodities are collectively packed and delivered, and normal commodities are collectively packed and delivered. In this case, since plural records of the received user ID and the status flag=0 are detected, it is necessary to judge that the home delivery request is made for a commodity relating to which package, and it is necessary to prepare information for that in the representative number management table (FIG. 5) and the like.

At step S65, in the case where it is judged that the commodity and the store do not exceed the regulation, the representative number is identified from the representative number management table (FIG. 5) (step S67). Then, the record having the identical representative number is identified in the home delivery request reception table (FIG. 6), and a new record is generated (step S69). Then, a reception number (addition number) is issued on the basis of the records with which the representative number is coincident, and is registered in the new record, together with the received information from the user terminal (user ID, reception date and time, registration number, objective commodity name or number, special article flag, etc.) (step S71). Then, the delivery fee estimate processing is carried out (step S73). This delivery fee estimate processing will be described later. Then, a remaining time is calculated from a difference between the instruction start time and the deadline time of the representative number management table (FIG. 5) (step S75). Then, the page data for indicating the reception of the home delivery request, including the remaining time and the result of the delivery fee estimate processing is generated and is transmitted to the user terminal (step S77). With respect to the additional home delivery request, in order to inform the user how long the home delivery request can be received from this time, the display column 816 of the remaining time in the example of FIG. 16 is provided. After step S93, step S77, or step S111, the processing returns to the original flow.

By doing so, it becomes possible to deal with a new home delivery request, an additional home delivery request, a case in which a commodity or store relating to the home delivery request exceeds the regulation.

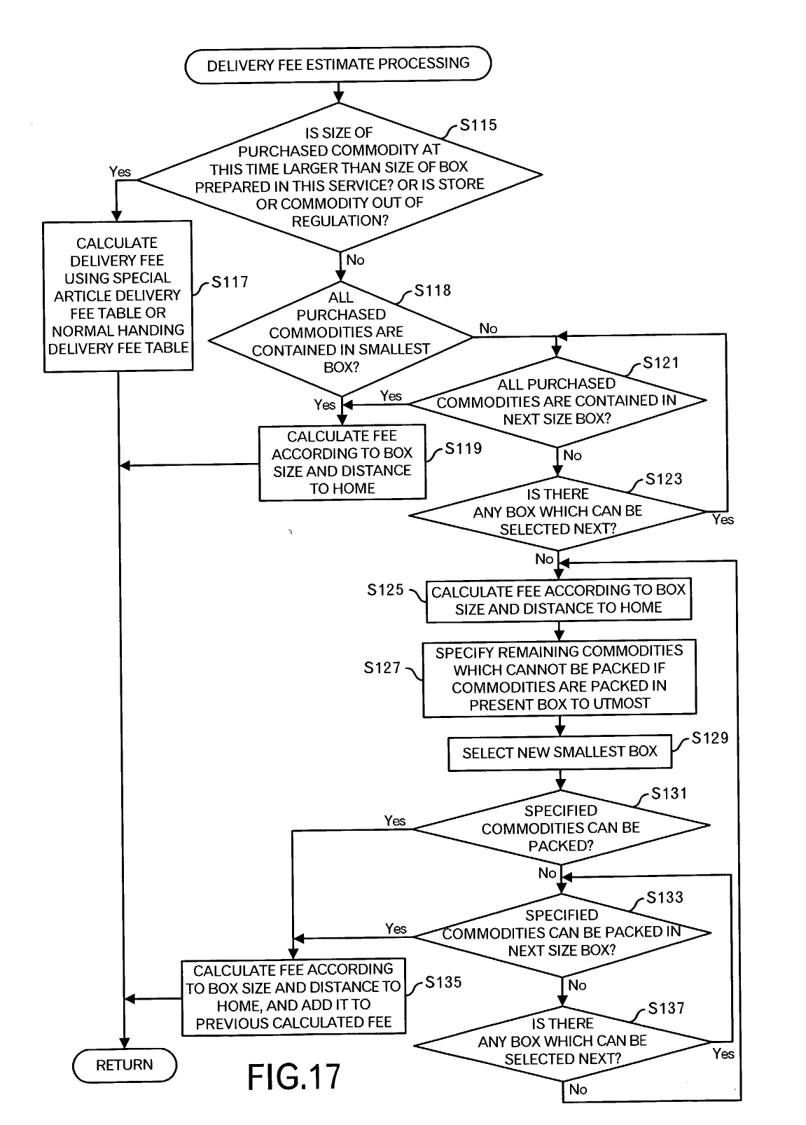

Next, the delivery fee estimate processing will be described with reference to FIG. 17. First, it is judged whether the size of this purchased commodity is larger than a box prepared in this service, or whether a store or a commodity exceeds the regulation (step S115). In the case where the commodity is excessively large or a frozen commodity, or the store is positioned outside the normal pickup area, it can not be packed together, and it is treated as a separately delivered article. Accordingly, when it is judged that the condition at step S115 is satisfied, in the case of the frozen commodity or excessively large commodity, a delivery fee is simply calculated in accordance with the special article delivery fee table (FIG. 10), and in the case where the store is positioned outside the normal pickup area, a delivery fee is calculated using a normal handling delivery fee table (not shown) (step S117).

On the other hand, in the case where the commodity can be packed together and the store is in the normal pickup area, it is judged whether all purchased commodities up to this time can be contained in a smallest box (step S118). Size information of the commodity, which is transmitted from the user terminal, is used for this judgment. In case where all the purchased commodities are contained in the smallest box, a fee calculation is carried out in accordance with the size of the box and the distance to the user's house (or place specified by the user) (step S119). At that time, the packing estimate table (FIG. 9) is used. In the example of FIG. 9, although data of the distance is not indicated, information of the distance is also considered. However, the delivery fee may be fixed only by the size.

On the other hand, in the case where they can not be contained in the smallest box, it is judged whether all purchased commodities are contained in a next size box (step S121). If they are contained, the processing proceeds to the step S119, and the fee calculation in accordance with the size of the box and the distance to the house is carried out.

In case it is judged that all the purchased commodities are not contained in the box at the step S121, it is judged whether there is a box of a size, which can next be selected (step S123). In case such a box is prepared, the processing returns to the step S121. On the other hand, in case there is no box of a size, which can next be selected, it is indicated that they can not be packed in one box. Accordingly, it is assumed that the commodities are contained in the largest box to the utmost, and the calculation of the delivery fee is carried out in accordance with the size of the box and the distance to the house or the like (step S125). Besides, the number of boxes (the initial value is 1) is incremented by one. Then, the remainder, which can not be contained if commodities are packed in the present box to the utmost, is specified (step S127). Then, the smallest new box is selected (step S129).

Then, it is judged whether the purchased commodities specified at the step S127 are contained in the box selected at the step S129 (step S131). If they are contained, the delivery fee is calculated in accordance with the size of the new box and the distance to the house, and is added to the delivery fee of other box calculated before (step S135). On the other hand, if the purchased commodities specified at the step S127 can not be contained in this box, it is judged whether they can be contained in a next size box (step S133). If they are contained, the delivery fee in accordance with the size of the box and the distance to the house are calculated, and is added to the delivery fee of other box calculated before. In the case it is judged at the step S133 that they can not be contained in the next size box, it is judged whether there is a box of a size, which can next be selected (step S137). In case a next size box is prepared, the processing returns to the step S133. On the other hand, in case there is no box of a size, which can next be selected, the processing returns to the step S125. That is, this means that the largest box is again filled up, and the delivery fee of the box is calculated. Besides, the number of boxes is incremented by one. Then, the calculation of the delivery fee of the purchased commodities, which have not been packed, is carried out as described above.

By carrying out such processing, the delivery fee can be calculated with a less number of boxes, so that a large cost merit is produced for the user.

As described above, the user can purchase commodities in plural stores or the like. That is, the step S1 to step S31 of FIG. 12 are repeated.

In this embodiment, as set at step S99 of FIG. 15, a home delivery request is received for a predetermined time A. This is determined in view of the trouble of pickup, management, packing, and delivery of purchased commodities in the delivery company. However, the predetermined time A can be extended for a user's convenience for shopping or the like. With respect to the extension, there is a case where the number of times of extension is restricted or free. In this embodiment, only one extension can be made.

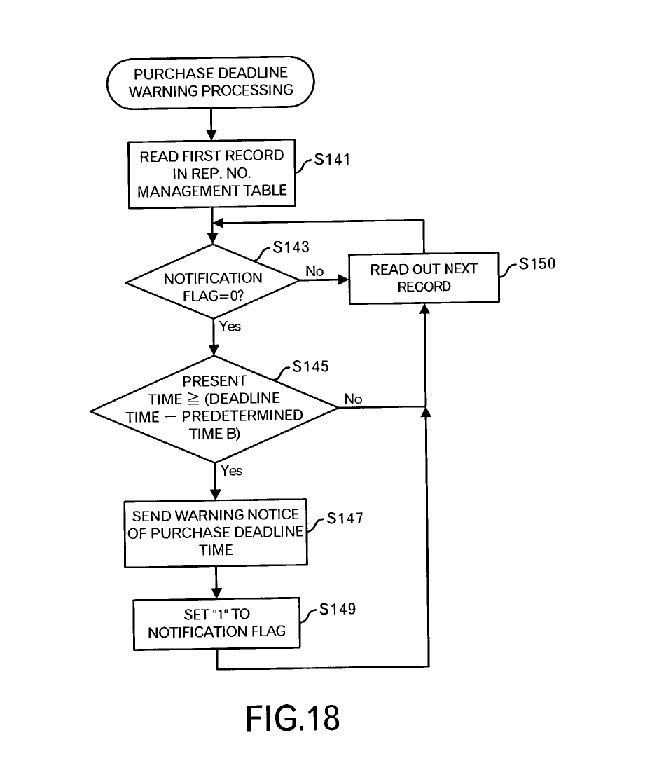

Next, a description will be given of a processing in a case where a time has passed since the instruction start time as the first home delivery request time (in FIG. 5, time stored in the column 503 of the instruction start time). At first, a purchase deadline warning processing for notifying the user that the deadline time for reception of the home delivery request is pressing, will be described with reference to FIG. 18. The packing and delivery related processor 33 reads out the first record of the representative number management table (FIG. 5) (step S141). Then, it is judged whether the notification flag of the record is “0” (warning is not issued) (step S143). If the notification flag is “1”, a next record is read out from the representative number management table (step S150), and the processing returns to the step S143.

On the other hand, if the notification flag is “0”, the packing and delivery related processor 33 confirms whether the present time is a predetermined time B (for example, 10 minutes) before the deadline time included in the record (step S145) or after that. For example, if the deadline time is 18:00, it is confirmed whether the present time is 17:50 or after that. In case the present time does not reach the predetermined time B before the deadline time, the processing proceeds to step S150. On the other hand, in the case where the present time is the predetermined time B before the deadline or after that, a warning notice of the purchase deadline time is transmitted by, for example, e-mail (step S147). The e-mail address is acquired from the user master DB 35 (FIG. 3). In addition, a telephone call may be made to the cellular phone 7 of the user or the like. Then, the notification flag of the representative number management table (FIG. 5) is set to “1” (step S149). Then, the processing returns to the step S150. Incidentally, in the case where there is no next record at the step S153, the processing returns to the first record.

In this way, among records in which the warning notice of the purchase deadline time is not given, a search is always made for a record in which the present time is the predetermined time B before the deadline time or after that, and the warning notice of the purchase deadline time is carried out to the user relating to the record.

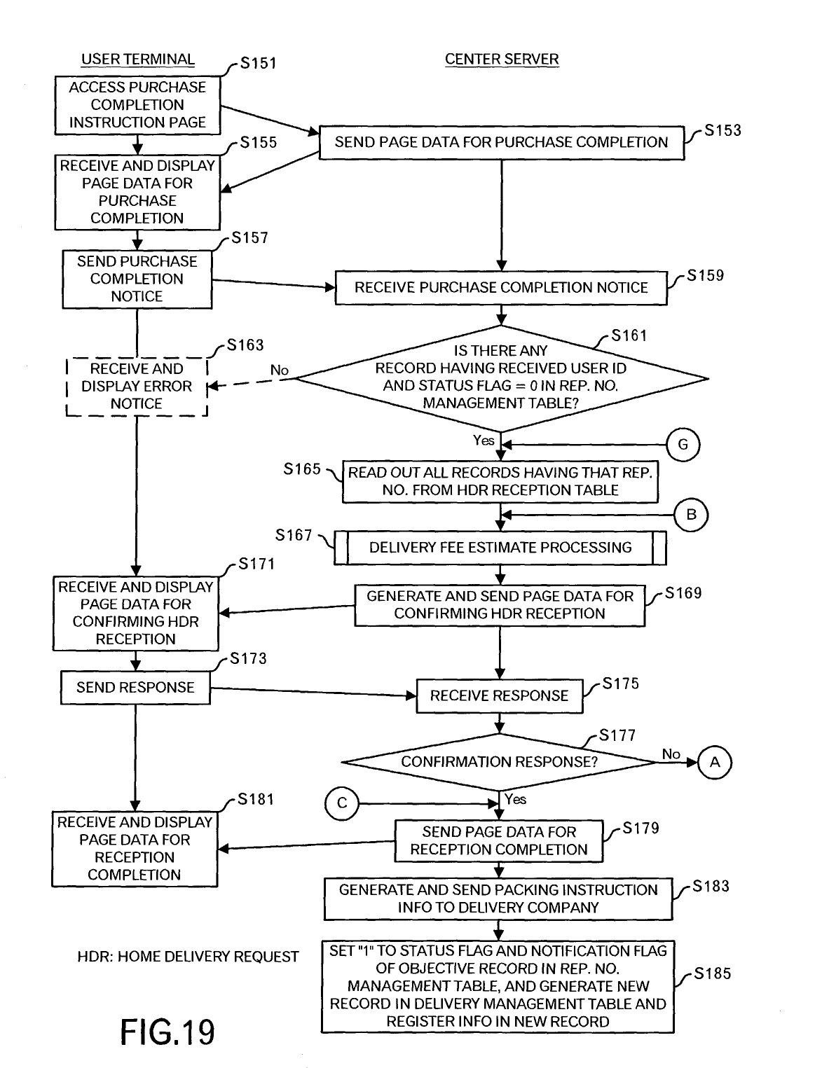

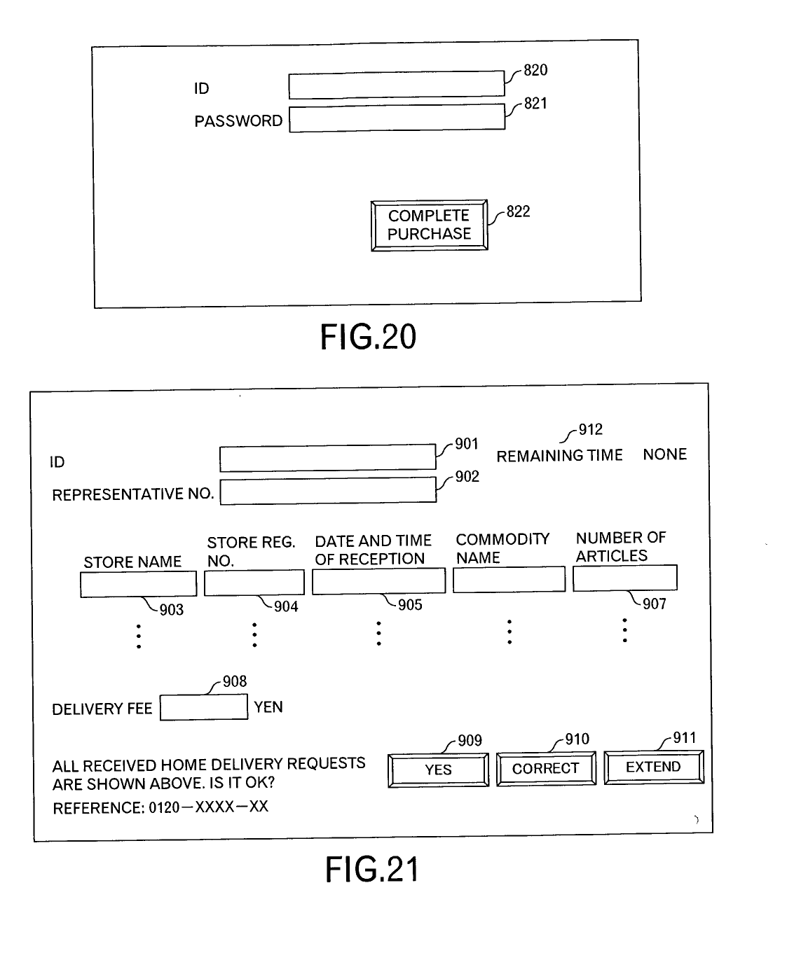

Next, a processing flow in a case where the user voluntarily notifies the purchase completion to the center server 3 at the end of shopping, will be described with reference to FIGS. 19 to 23. The user terminal such as the cellular phone 7 accesses the purchase completion instruction page in accordance with the instruction of the user (step S151). The packing and delivery related processor 33 of the center server 3 transmits the page data for the purchase completion to the user terminal in response to the access (step S153). The user terminal receives the page data for the purchase completion from the center server 3, and displays it on the display device (step S155). For example, a screen as shown in FIG. 20 is displayed. In the example of FIG. 20, there are provided an input column 820 of a user ID, an input column 821 of a password, and a purchase complete button 822.

The user operates the user terminal to input the user ID and the password, and clicks the purchase completion button 822. Then, the user terminal transmits the purchase completion notification including the user ID and the password to the center server 3 (step S157). When receiving the purchase completion notification including the user ID and the password from the user terminal, the packing and delivery related processor 33 of the center server 3 carries out an authentication processing using the user ID, the password, and the information stored in the user master DB 35 (step S159). Since the authentication processing itself is not changed from the related art, the description is omitted, and here, it is assumed that the authentication processing is successfully completed.

Besides, the representative number management table (FIG. 5) is searched using the user ID, and it is judged whether there is a record having the received user ID and the status flag=0 (“0” denotes that purchase completion or automatic purchase completion processing has not been carried out.) in the representative number management table (step S161). If there is no record, an error notice is transmitted to the user terminal. The user terminal receives the error notice from the center server 3 and displays it on the display device (step S163).

On the other hand, in the case where the record having the received user ID and the status flag=0 exists, all records having the representative number of the record are read out from the home delivery request reception table (FIG. 6) (step S165). Then, the delivery fee estimate processing (FIG. 17) is carried out using the information of the read records (step S167). Then, page data for confirming the home delivery request reception, including the delivery fee estimate result is generated and is transmitted to the user terminal (step S169). The user terminal receives the page data for confirming the home delivery request reception, and displays it on the display device by the Web browser (step S171).

An example of the page data for confirming the reception of the home delivery request is shown in FIG. 21. The example of FIG. 21 includes a display column 901 of a user ID, a display column 902 of a representative number, a display column 903 of a store name, a display column 904 of a store registration number, a display column 905 of a reception date and time, a display column 906 of a commodity name, a display column 907 of the number of commodities, a display column 908 of a delivery fee, an YES button 909 to instruct the confirmation of the contents of the home delivery request reception, a correct button 910 to correct the home delivery request, an extend button 911 to extend a purchase deadline, and a display column 912 to display a remaining time to the purchase deadline. Incidentally, in the case where the user voluntarily performs the purchase completion instruction, since there is no possibility of extension, the extension button 911 is not included on the page for confirming the home delivery request reception, displayed at step S171.

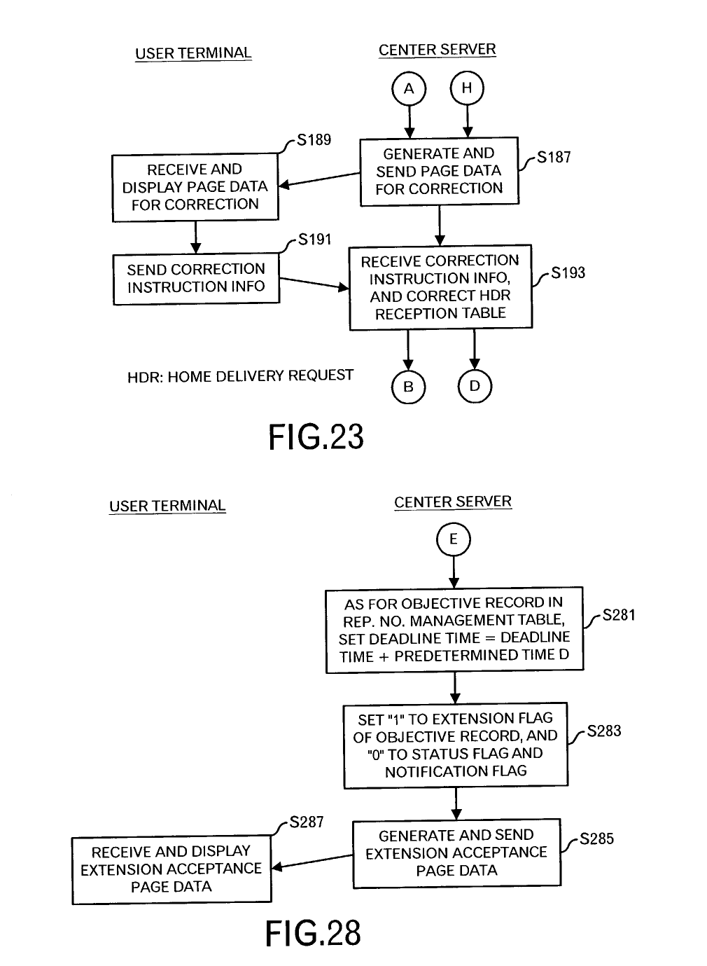

The user confirms the content of the displayed page for confirming the home delivery request reception. If there is a problem, the user may call customer service. If there is no problem, the YES button 909 is clicked, and in the case where a correction has to be performed on the screen, the correct button 910 is clicked. The user terminal transmits a response to the center server 3 in accordance with the click by the user (step S173). The packing and delivery related processor 33 of the center server 3 receives the response from the user terminal (step S177), and judges whether the response is a confirmation response (step S177). In case the response is not the confirmation response, but a correction response, the processing proceeds to FIG. 23 through terminal A. On the other hand, if the response is the confirmation response, page data for confirming the reception completion, including a message to the effect that packing and delivery are started is transmitted (step S179). The user terminal receives the page data for confirming the reception completion from the center server 3, and displays it on the display device (step S181) Then, packing instruction information to the delivery company is generated and is transmitted to the delivery company server 15 (step S183). For example, information as shown in FIG. 22 is transmitted as the packing instruction information. The example of FIG. 22 includes a column 871 of a user ID, a column 872 of a name, a column 873 of an address, a column 874 of a telephone number, a column 875 of a purchase store, a column 876 of a reception number, a column 877 of a reception commodity or number of a home delivery request, and a column 878 of a special article flag. When receiving the packing instruction information from the center server 3, the delivery company server 15 stores it in the storage device. The delivery company checks the packing instruction information, the pickup instruction information, and the information read out from the IC tag to suitably perform packing, and delivers the packed article.

The packing and delivery related processor 33 of the center server 3 sets the status flag and the notification flag of the record to “1” in the representative number management table. Incidentally, although there is also a case where the notification flag has already been set to “1”, in that case, it is not changed. Besides, a new record is generated in the delivery management table (FIG. 8) (step S185). In the new record, the representative number is registered, the purchase completion instruction check is set to “1”, and the information of the date and time when the purchase completion instruction is received is recorded. Besides, the packing instruction check is set to “1”, and information of the date and time when the packing instruction is transmitted is recorded.

Next, a processing in a case where the response received from the user terminal is the correction response will be described with reference to FIG. 23. The processing proceeds to FIG. 23 from FIG. 19 through the terminal A. In this case, the packing and delivery related processor 33 generates page data for correction to enable indication of information concerning the home delivery request to be corrected and transmits it to the user terminal (step S187). The user terminal receives the page data for correction from the center server 3 and displays it on the display device (step S189). The user sees the displayed page for correction, inputs suitable correction instruction, and orders transmission of the correction instruction. The user terminal transmits the correction instruction information to the center server 3 according to the user's order (step S191). When receiving the correction instruction from the user terminal, the packing and delivery related processor 33 of the center server 3 corrects the home delivery request reception table (FIG. 6) in accordance with the correction instruction (step S193). Then, the processing returns to the step S167 of FIG. 19 through terminal B.

In this way, packing and delivery are performed in accordance with the purchase completion instruction by the user. Besides, in the page for confirming the home delivery request reception, the contents of the home delivery request can be confirmed, and in the case where a correction is necessary, an instruction to perform the correction can also be issued.

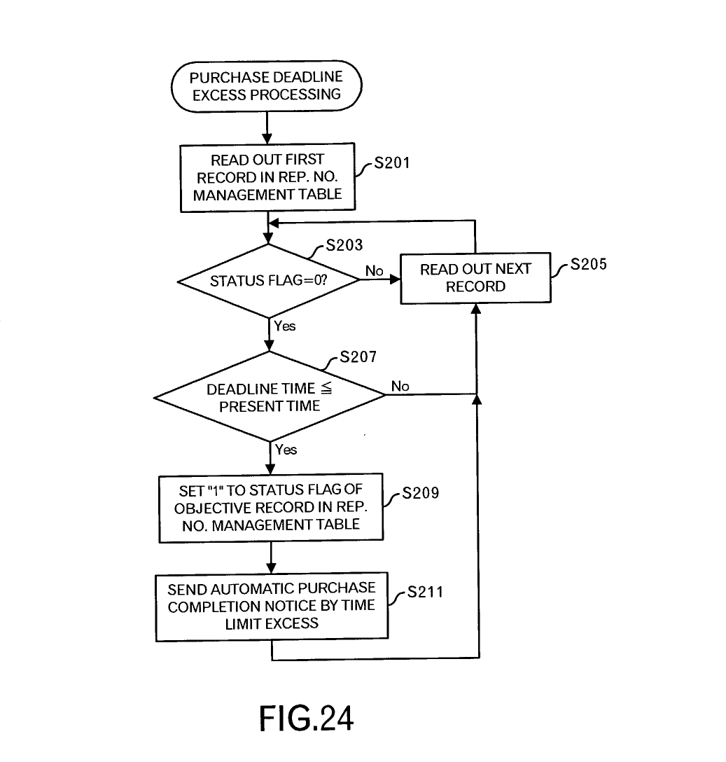

Next, a processing of a case where the user does not voluntarily give purchase completion instruction and a time reaches the deadline time of the home delivery request reception, will be described with reference to FIG. 24. The packing and delivery related processor 33 reads out the first record of the representative number management table (FIG. 5) (step S201). Then, it is confirmed whether the status flag of the record is “0” (purchase completion or automatic purchase completion processing has not been carried out) (step S203). In case the status flag is not “0”, that is, in case the status flag is “1”, a next record is read out (step S205) Then, the processing returns to the step S203.

In the case of the status flag=0, it is confirmed whether the present time is after the deadline time of the record (step S207). In case the present time is before the deadline time, the processing proceeds to the step S205. On the other hand, in case the present time is after the deadline time, the status flag of the record in the representative number management table is set to “1” (step S209). That is, it is assumed that the purchase completion instruction is automatically made, and the reception of the home delivery request is closed. Then, the automatic purchase completion notice by the excess of the time limit is transmitted to the user corresponding to the representative number by, for example, e-mail (step S211). For example, the notice includes a message such as “Since a purchase completion notice was not received by the time limit, reception was automatically closed”. Concerning the notification destination to the user, such as an e-mail address, the information stored in the user master DB 35 is used. After the step S211, the processing returns to the step S205. Incidentally, in the case where there is no next record at the step S205, the processing returns to the first record.

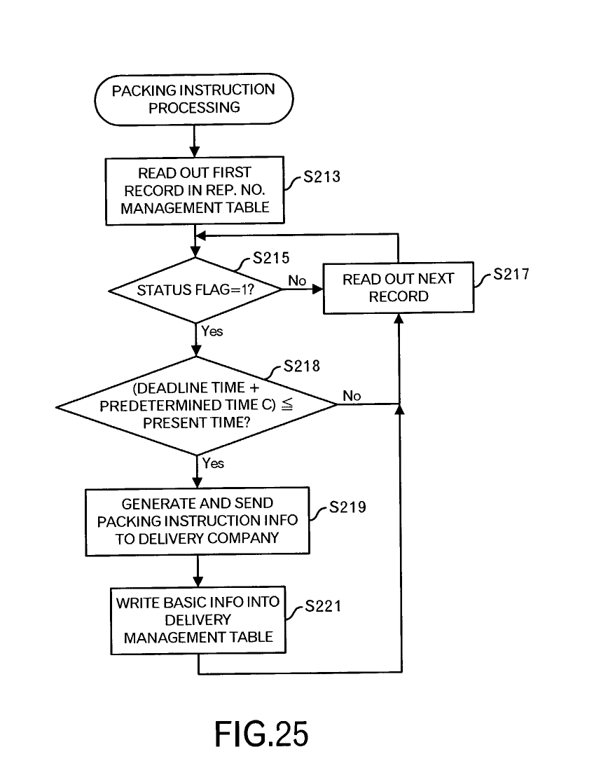

By this, a packing instruction processing described next is automatically performed, and packing and delivery by the delivery company are started. The packing instruction processing will be described with reference to FIG. 25. First, the packing and delivery related processor 33 reads out the first record of the representative number management table (step S213). Then, it is judged whether the status flag of the record is “1” (step S215). That is, it is confirmed whether purchase completion is set. If the status flag is “0”, a next record is read out (step S217), and the processing proceeds to step S215.

On the other hand, in the case of the status flag=1, it is confirmed whether the present time is after a time when a predetermined time C (for example, 5 minutes) has passed since the deadline time (step S218). The predetermined time C is a time in which an extension instruction by the user is accepted after the deadline time. Incidentally, in the case where it is configured not to accept the extension instruction, it is merely confirmed whether the present time has passed the deadline time. In case the present time is before a time when the predetermined time C has passed since the deadline time, the processing proceeds to step S217.

In case the present time is later than the time when the predetermined time C has passed since the deadline time, delivery instruction information (FIG. 22) to the delivery company is generated, and is transmitted to the delivery company server 15 (step S219). Then, a new record is generated in the delivery management table (FIG. 8), the representative number is registered, the purchase completion instruction check is set to “1”, and the information of the date and time when the purchase completion instruction is received is recorded. Besides, the packing instruction check is set to “1”, and as the date and time when the packing instruction is transmitted, the information of the time of this processing is stored (step S221). Then, the processing proceeds to step S217. At the step S217, in case there is no next record, the first record is read out.

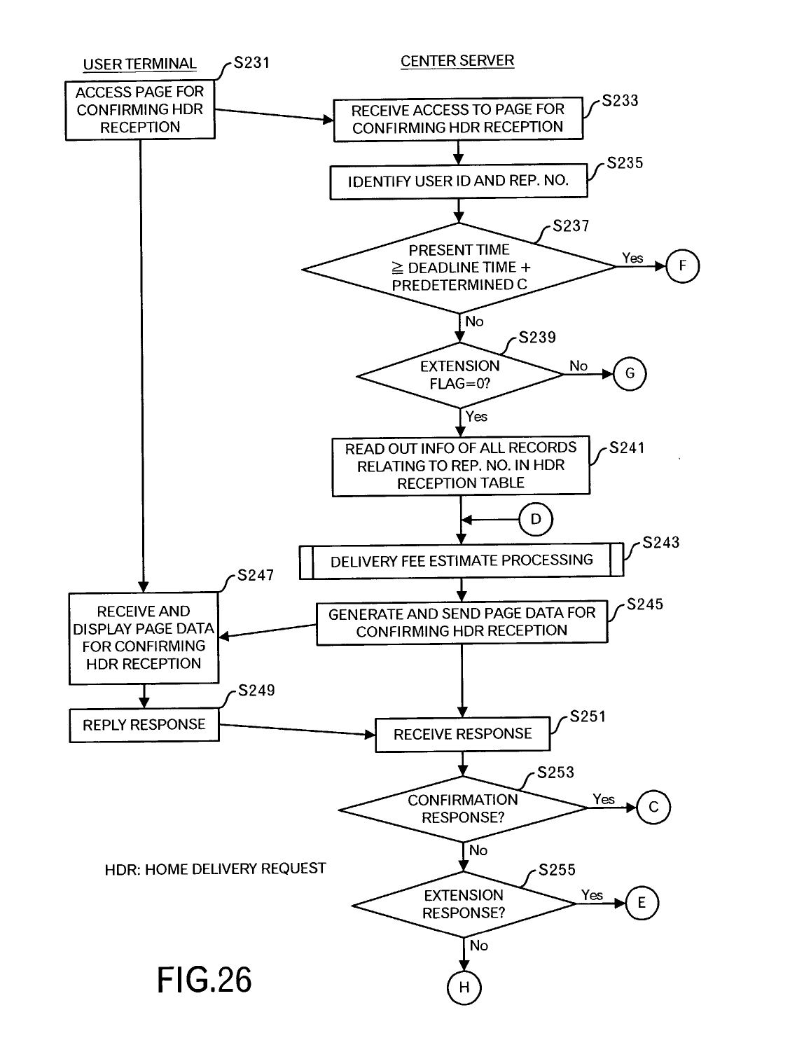

The user can confirm the user's home delivery request at any time. For example, a link to a page for confirming the home delivery request reception is included in an e-mail of a warning notice of the purchase deadline time or an automatic purchase completion notice. The user selects the link and can access the page for confirming the home delivery request reception. In addition, transition to the page for confirming the home delivery request reception may be made successively from the main menu of the center server 3. Incidentally, the content of the page for confirming the home delivery request reception is different according to the timing of the access. Hereinafter, except for a case where the page for confirming the home delivery request reception is displayed in accordance with the purchase completion instruction, a processing at the time of access to the page for confirming the home delivery request reception will be described with reference to FIGS. 26 to 28.

The user terminal such as the cellular phone 7 accesses the page for confirming the home delivery request reception in accordance with the instruction of the user (step S231). The packing and delivery related processor 33 of the center server 3 receives the access to the page for confirming the home delivery request reception from the user terminal (step S233). The packing and delivery related processor 33 identifies the user ID and the representative number in response to the access (step S235) For example, in the case where a link address included in the warning notice of the purchase deadline time or the automatic purchase completion notice is constituted by a combination of the user ID and the representative number, this information may be used. If the user ID and the representative number are inputted by the time of the access to this page, such information is used. Incidentally, the representative number management table (FIG. 5) may be searched with the user ID to extract the representative number. There is also a case where the authentication processing is carried out.

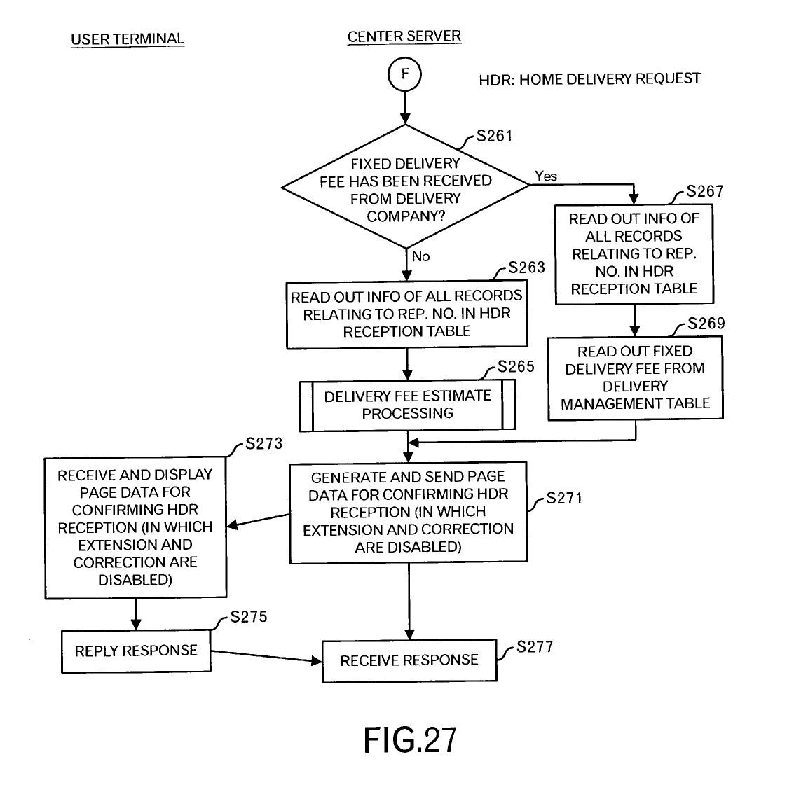

Next, the representative number management table is searched with the representative number to read out the record, and it is confirmed whether the present time is after the time when the predetermined time C has passed since the deadline time (step S237). That is, it is judged whether the time when the deadline can be extended has passed. In case the present time is after the time when the predetermined time C has passed since the time limit, the processing proceeds to the processing of FIG. 27 through terminal F. On the other hand, in case the present time is before the time when the predetermined time C has passed since the time limit, it is judged whether the extension flag is “0” (step S239). The extension flag=0 means that the purchase deadline time has never been extended. In this embodiment, the extension can be made only once, and in the case where one extension has been already made, the processing proceeds to the step S167 of FIG. 19 through terminal G. That is, although the present time is a time when the deadline is extendable, since extension has already been made once and can not be made any more, a page for confirming the home delivery request reception, in which an extension can not be instructed, is displayed. This is the same as the case where the purchase completion instruction is made by the user.

On the other hand, in the case of the extension flag=0, information of all records in the home delivery request reception table (FIG. 6), which relates to the representative number, is read out (step S241), and the delivery fee estimate processing (FIG. 17) is carried out (step S243). Then, the page data for confirming the home delivery request reception (FIG. 21), including the delivery fee estimate result and the remaining time (=deadline time−present time), is generated and is transmitted to the user terminal (step S245). The user terminal receives the page data for confirming the home delivery request reception and displays it on the display device (step S247). The page for confirming the home delivery request reception displayed at the step S247 includes the YES button 909, the correction button 910, and the extension button 911. Accordingly, the user can instruct the confirmation response, the correction response, and the extension response.

The user terminal transmits a response to the center server 3 in accordance with the instruction of the user (step S249). The packing and delivery related processor 33 of the center server 3 receives the response from the user terminal (step S251), and judges whether it is the confirmation response (step S253). In case it is the confirmation response, the processing proceeds to the step S179 of FIG. 19 through terminal C. On the other hand, in case it is not the confirmation response, it is judged whether the response is the extension response (step S255). In the case of the extension response, the processing proceeds to the processing of FIG. 28 through terminal E. On the other hand, in case it is not the extension response, it is the correction response. Therefore, in this case, the processing proceeds to the processing of FIG. 23 through terminal H. Incidentally, in FIG. 23, in the case where transition has been made from terminal H, the processing returns to the step S243 of FIG. 26 through terminal D.

Next, a processing in the case where transition has been made from the step S237 of FIG. 26 through terminal F will be described with reference to FIG. 27. The packing and delivery related processor 33 first judges whether the fixed delivery fee is received from the delivery company server 15 (step S261). In case the fixed delivery fee is received from the delivery company server 15, since the fixed delivery fee is registered in the delivery management table (FIG. 8) (transmission status check is “1”), it is possible to make a judgment by that. In case the fixed delivery fee is received, information of all records in the home delivery request reception table (FIG. 6), which relates to the representative number, is read out (step S267). Besides, information of the fixed delivery fee is read out from the delivery management table (FIG. 8) (step S269).

On the other hand, in the case where the fixed delivery fee is not received, information of all records in the home delivery request reception table (FIG. 6), relating to the representative number, is read out (step S263), and the delivery fee estimate processing (FIG. 17) is carried out (step S265).

Then, after the step S265 or the step S269, the page data for confirming the home delivery request reception, including the information of all relating records in the home delivery request reception table (FIG. 6), and the information of the delivery fee estimate result or the fixed delivery fee is generated, and is transmitted to the user terminal (step S271). The user terminal receives the page data for confirming the home delivery request reception from the center server 3 and displays it on the display device (step S273). The page for confirming the home delivery request reception displayed at this step S273 does not include the correction button 910 and the extension button 911. At this stage, since the packing instruction has been already transmitted to the delivery company server 15, it is in the state where both the correction and the extension can not be made. Accordingly, at this step, buttons for those are not displayed. Accordingly, the response instructed by the user is only the confirmation response. When the user clicks the YES button 909, the user terminal transmits the response to the center server 3 (step S275). The center server 3 receives the response from the user terminal (step S277). A processing subsequent to this step may be constructed, for example, so as to shift to another menu screen.

Next, a processing in the case where it is judged at the step S255 in FIG. 26 that the response is the extension response will be described with reference to FIG. 28. This processing is shifted to FIG. 28 through terminal E. First, the packing and delivery related processor 33 renews the deadline time of the record of that representative number to ((the present time)+(a predetermined time D (for example, one hour))) (step S281). Besides, the extension flag of the record is set to “1”, and the status flag and the notification flag are set to “0” (step S283). Then, extension acceptance page data is generated, and is transmitted to the user terminal (step S285). The user terminal receives the extension acceptance page data from the center server 3 and displays it on the display device (step S287).

In this way, the deadline time is extended, and the user continues shopping and can transmit an additional home delivery request. Incidentally, since the status flag is “0”, the purchase completion or automatic purchase completion processing again becomes necessary. Besides, since the notification flag is “0”, a notice can be received again before a new deadline.

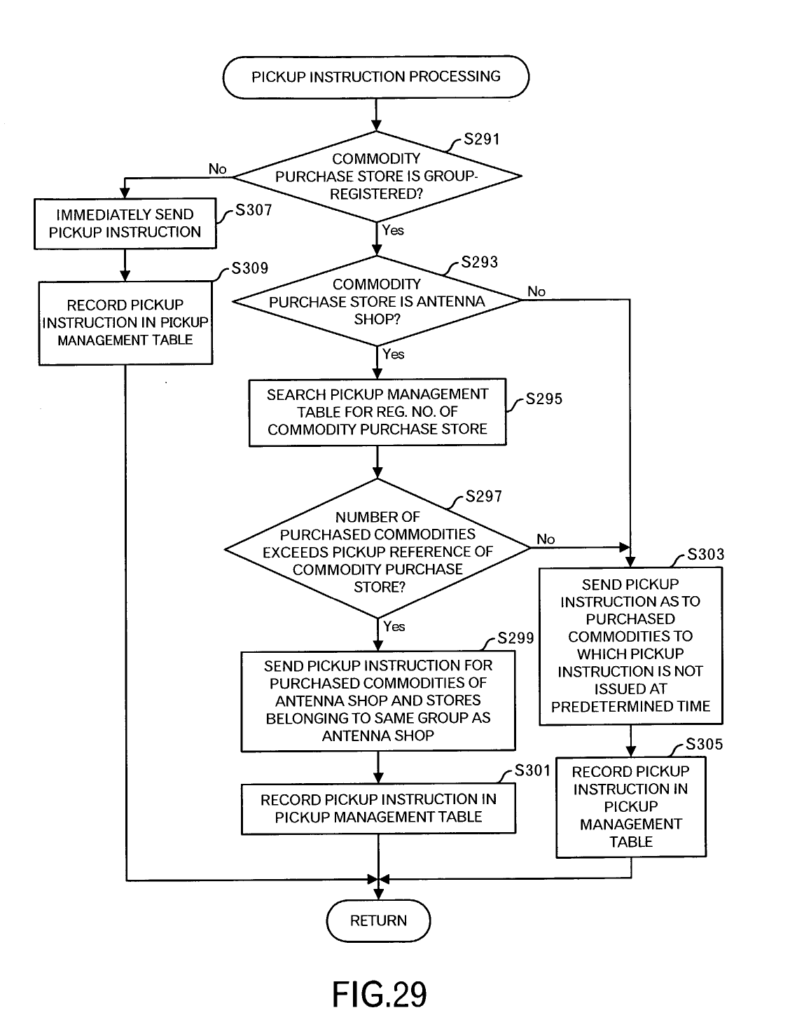

Although one embodiment of the present invention has been described, the invention is not limited to this. Especially, although the pickup instruction processing may be simply carried out each time the home delivery request is received from the user terminal, a processing as shown in FIG. 29 may be carried out.

That is, the pickup related processor 32 refers to the store master DB 36 and judges whether the commodity purchase store is group-registered (step S291). That is, it is judged whether the group number is registered in the column 709 of the pickup group of the store master DB 36. If it is not registered, a pickup instruction is immediately generated, and is transmitted to the delivery company server 15 (step S307). Then, the pickup instruction check of the pickup management table (FIG. 7) is set to “1”, and the transmission date and time are registered (step S309). Then, the processing returns to the original flow.

On the other hand, in the case of the group-registered store, it is judged whether the commodity purchase store is the antenna store (step S293). This judgment is based on whether a certain numeral is registered in the column 708 of the pickup reference of the antenna store in the store master DB 36 (FIG. 4). In case it is not the antenna store, the processing proceeds to step S303. On the other hand, in the case of the antenna store, the pickup management table (FIG. 7) is searched with the registration number of the commodity purchase store, and the pickup reference data is acquired (step S295). Then, it is judged whether the number of purchased articles exceeds the pickup reference of the commodity purchase store (step S297). Incidentally, only the records in which the pickup instruction status check is “0” are counted. In case the number of purchased articles does not exceed the pickup reference in the pickup management table (FIG. 7), the processing proceeds to step S303.

In case the number of purchased articles exceeds the pickup reference in the pickup management table, the purchase commodity of the store belonging to the same group as the antenna store is extracted from the pickup management table. At this time, only the record in which the pickup instruction status check is “0” is extracted. Then, information of the pickup instruction relating to the extracted purchased commodities is generated and is transmitted to the delivery company server 15 (step S299). The pickup instruction flag of the record relating to the pickup instruction in the pickup management table is set to “1”, and the date and time of the pickup instruction transmission is registered (step S301) Then, the processing returns to the original flow.

Incidentally, if the pickup instruction is not issued unless the number reaches the pickup reference in the antenna store, there can occur a case where the pickup is not made for some days. Thus, in this embodiment, in the case where it is judged that the store is not the antenna store at step S293, and in the case where the number of purchased articles does not exceed the pickup reference in the antenna store, a purchased commodity (pickup instruction status check is “0”) not issuing the pickup instruction at a predetermined time is extracted in the pickup management table, the information of the pickup instruction relating to the extracted purchased commodity is generated, and is transmitted to the delivery company server 15 (step S303). Then, the pickup instruction status check of the record relating to the pickup instruction in the pickup management table is set to “1”, and date and time of the pickup instruction transmission is registered (step S305). Then, the processing returns to the original flow.

Besides, in the above, although it is premised that the delivery company staff member always goes to the stores to pickup cargos, in recent years, there is also a case where the delivery company stocks commodities of plural stores in the warehouse and delivers to the customer from the warehouse. Thus, also in the invention, the configuration like this can be applied as it is. At that time, the pickup instruction is transmitted to the delivery company server 15 from the center server 3 as it is, and the delivery company server 15 may judge whether the commodity is one to be picked from the warehouse.

Besides, in the above, such a configuration is adopted that in the case where a store is positioned outside a normal pickup area, and in the case where the commodity is a special article or an excessively large size, it is delivered separately. However, these are further classified, and the way of delivery may be changed.

Further, the function blocks in the system schematic outline shown in FIG. 2 are merely examples, and actual program modules can also be configured according to another manner. Besides, the manner of data storage may be different from the way as shown in FIG. 2. The screen configurations of the screen examples of FIGS. 13, 16, 20 and 21 are merely examples, and the invention is not limited to these as long as similar contents are displayed. Although described above as well, there is also a case where the respective screens are divided into plural screens and are presented.

Although the screen example requesting the input of the ID is shown, there is also a case where the input of the user ID is omitted because of the subscriber ID or IPv6 address. With respect to the user ID input column, there is also a case where the Web page data is generated, transmitted, and displayed in a state where the user ID is embedded.

Incidentally, although the embodiment described above shows one delivery company, there can be a case where plural delivery companies cooperate with each other. Besides, there can be a case where different transportation agencies, for example, taxis or the like are incorporated in the pickup processing portion of the invention.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A delivery information processing method comprising the steps of:
receiving a delivery request to deliver a purchased commodity from a purchase store; and
if a purchase completion instruction is received, transmitting to a delivery company, a packing instruction of purchased commodities meeting a predetermined condition among all purchased commodities relating to said delivery requests received before reception of said purchase completion instruction.

2. The delivery information processing method as set forth in claim 1, further comprising a step of, if said purchase completion instruction is not received by a predetermined timing, transmitting to said delivery company, a packing instruction of purchased commodities meeting said predetermined condition among said all purchased commodities relating to said delivery requests received by said predetermined timing.

3. The delivery information processing method as set forth in claim 1, further comprising a step of, if said purchase completion instruction is not received though a predetermined time has passed since a first delivery request was received, transmitting to said delivery company, a packing instruction of purchased commodities meeting said predetermined condition among said all purchased commodities relating to said delivery requests received before elapse of said predetermined time.

4. The delivery information processing method as set forth in claim 3, further comprising a step of, if an extension request of said predetermined time is received, setting an extension of said predetermined time.

5. The delivery information processing method as set forth in claim 3, further comprising a step of, if said purchase completion instruction is not received though said predetermined time has passed since said first delivery request was received, notifying a user of a reception completion of said delivery request.

6. The delivery information processing method as set forth in claim 3, further comprising a step of previously notifying a user of a reception completion of said delivery request at a predetermined timing before said predetermined time passes.

7. The delivery information processing method as set forth in claim 1, further comprising the steps of:
estimating a delivery fee by using information concerning said delivery request in response to a request from a user terminal; and
transmitting estimate information of said delivery fee to said user terminal.

8. The delivery information processing method as set forth in claim 1, further comprising a step of, if a delivery request to deliver a purchased commodity from a purchase store is received, transmitting a pickup instruction of said purchased commodity to a computer of a delivery company.

9. The delivery information processing method as set forth in claim 1, wherein said packing instruction includes information concerning delivery destination specified by a user.

10. The delivery information processing method as set forth in claim 1, further comprising a step of, if a delivery request to deliver a purchased commodity from a purchase store is received, transmitting to a user terminal or to a computer of said purchase store, information used at least for packing said purchased commodity by said delivery company.

11. The delivery information processing method as set forth in claim 1, wherein said predetermined condition is that said purchase store is a store other than a previously specified store or that said purchased commodity is a commodity other than a previously specified store.

12. The delivery information processing method as set forth in claim 1, further comprising a step of, if information concerning a fixed delivery fee by packing of said delivery company is received, notifying a user of said information concerning said fixed delivery fee.

13. The delivery information processing method as set forth in claim 1, further comprising a step of, if a predetermined number of or more delivery requests to deliver from a specific purchase store are received, transmitting to the delivery company, a pickup request of purchased commodities for said specific purchase store and a store related to said specific purchase store.

14. The delivery information processing method as set forth in claim 1, further comprising the steps of:
if a confirmation request for said delivery request status is received from a user terminal, judging whether or not information concerning a fixed delivery fee is received from said delivery company;
if said information concerning said fixed delivery fee has already been received, transmitting to the user, information concerning said purchased commodities included in information concerning the received delivery requests and said information concerning said fixed delivery fee;
if said information concerning said fixed delivery fee has not been received yet, transmitting to the user, information concerning said purchased commodities included in information concerning the received delivery requests and an estimate result of said delivery fee.

15. A delivery information processing method comprising the steps of:
receiving a delivery request to deliver a purchased commodity from a purchase store is received; and
after a predetermined timing, transmitting to a delivery company, a packing instruction of purchased commodities meeting a predetermined condition among all purchased commodities relating to said delivery requests received before said predetermined timing.

16. A program embodies on a medium for performing a delivery information processing, said program comprising the steps of:
receiving a delivery request to deliver a purchased commodity from a purchase store; and
if a purchase completion instruction is received, transmitting to a delivery company, a packing instruction of purchased commodities meeting a predetermined condition among all purchased commodities relating to said delivery requests received before reception of said purchase completion instruction.

17. The program as set forth in claim 16, further comprising a step of, if said purchase completion instruction is not received by a predetermined timing, transmitting to said delivery company, a packing instruction of purchased commodities meeting said predetermined condition among said all purchased commodities relating to said delivery requests received by said predetermined timing.

18. The program as set forth in claim 16, further comprising a step of, if said purchase completion instruction is not received though a predetermined time has passed since a first delivery request was received, transmitting to said delivery company, a packing instruction of purchased commodities meeting said predetermined condition among said all purchased commodities relating to said delivery requests received before elapse of said predetermined time.

19. The program as set forth in claim 18, further comprising a step of, if an extension request of said predetermined time is received, setting an extension of said predetermined time.

20. The program as set forth in claim 18, further comprising a step of, if said purchase completion instruction is not received though said predetermined time has passed since said first delivery request was received, notifying a user of a reception completion of said delivery request.

21. The program as set forth in claim 18, further comprising a step of previously notifying a user of a reception completion of said delivery request at a predetermined timing before said predetermined time passes.

22. The program as set forth in claim 16, further comprising the steps of:
estimating a delivery fee by using information concerning said delivery request in response to a request from a user terminal; and
transmitting estimate information of said delivery fee to said user terminal.

23. The program as set forth in claim 16, further comprising a step of, if a delivery request to deliver a purchased commodity from a purchase store is received, transmitting a pickup instruction of said purchased commodity to a computer of a delivery company.

24. The program as set forth in claim 16, wherein said packing instruction includes information concerning delivery destination specified by a user.

25. The program as set forth in claim 16, further comprising a step of, if a delivery request to deliver a purchased commodity from a purchase store is received, transmitting to a user terminal or to a computer of said purchase store, information used at least for packing said purchased commodity by said delivery company.

26. The program as set forth in claim 16, wherein said predetermined condition is that said purchase store is a store other than a previously specified store or that said purchased commodity is a commodity other than a previously specified store.

27. The program as set forth in claim 16, further comprising a step of, if information concerning a fixed delivery fee by packing of said delivery company is received, notifying a user of said information concerning said fixed delivery fee.

28. The program as set forth in claim 16, further comprising a step of, if a predetermined number of or more delivery requests to deliver from a specific purchase store are received, transmitting to the delivery company, a pickup request of purchased commodities for said specific purchase store and a store related to said specific purchase store.

29. The program as set forth in claim 16, further comprising the steps of:
if a confirmation request for said delivery request status is received from a user terminal, judging whether or not information concerning a fixed delivery fee is received from said delivery company;
if said information concerning said fixed delivery fee has already been received, transmitting to the user, information concerning said purchased commodities included in information concerning the received delivery requests and said information concerning said fixed delivery fee;
if said information concerning said fixed delivery fee has not been received yet, transmitting to the user, information concerning said purchased commodities included in information concerning the received delivery requests and an estimate result of said delivery fee.

30. A program embodied on a medium for performing a delivery information processing, said program comprising the steps of:
receiving a delivery request to deliver a purchased commodity from a purchase store is received; and
after a predetermined timing, transmitting to a delivery company, a packing instruction of purchased commodities meeting a predetermined condition among all purchased commodities relating to said delivery requests received before said predetermined timing.

31. A delivery information processing apparatus, comprising:
means for receiving a delivery request to deliver a purchased commodity from a purchase store; and
means for transmitting to a delivery company, if a purchase completion instruction is received, a packing instruction of purchased commodities meeting a predetermined condition among all purchased commodities relating to said delivery requests received before reception of said purchase completion instruction.

32. The delivery information processing apparatus as set forth in claim 31, further comprising: means for transmitting to said delivery company, if said purchase completion instruction is not received by a predetermined timing, a packing instruction of purchased commodities meeting said predetermined condition among said all purchased commodities relating to said delivery requests received by said predetermined timing.

33. The delivery information processing apparatus as set forth in claim 31, further comprising: means for transmitting to said delivery company, if said purchase completion instruction is not received though a predetermined time has passed since a first delivery request was received, a packing instruction of purchased commodities meeting said predetermined condition among said all purchased commodities relating to said delivery requests received before elapse of said predetermined time.

34. The delivery information processing apparatus as set forth in claim 33, further comprising: means for setting, if an extension request of said predetermined time is received, an extension of said predetermined time.

35. The delivery information processing apparatus as set forth in claim 33, further comprising: means for notifying, if said purchase completion instruction is not received though said predetermined time has passed since said first delivery request was received, a user of a reception completion of said delivery request.

36. The delivery information processing apparatus as set forth in claim 33, further comprising: means for previously notifying a user of a reception completion of said delivery request at a predetermined timing before said predetermined time passes.

37. The delivery information processing apparatus as set forth in claim 31, further comprising:
means for estimating a delivery fee by using information concerning said delivery request in response to a request from a user terminal; and
means for transmitting estimate information of said delivery fee to said user terminal.

38. The delivery information processing apparatus as set forth in claim 31, further comprising: means for transmitting, if a delivery request to deliver a purchased commodity from a purchase store is received, a pickup instruction of said purchased commodity to a computer of a delivery company.

39. The delivery information processing apparatus as set forth in claim 1, wherein said packing instruction includes information concerning delivery destination specified by a user.

40. The delivery information processing apparatus as set forth in claim 31, further comprising: means for transmitting, if a delivery request to deliver a purchased commodity from a purchase store is received, to a user terminal or to a computer of said purchase store, information used at least for packing said purchased commodity by said delivery company.

41. The delivery information processing apparatus as set forth in claim 31, wherein said predetermined condition is that said purchase store is a store other than a previously specified store or that said purchased commodity is a commodity other than a previously specified store.

42. The delivery information processing apparatus as set forth in claim 31, further comprising: means for notifying, if information concerning a fixed delivery fee by packing of said delivery company is received, a user of said information concerning said fixed delivery fee.

43. The delivery information processing apparatus as set forth in claim 31, further comprising: means for transmitting to the delivery company, if a predetermined number of or more delivery requests to deliver from a specific purchase store are received, a pickup request of purchased commodities for said specific purchase store and a store related to said specific purchase store.

44. The delivery information processing apparatus as set forth in claim 31, further comprising:
means for judging, in a case where a confirmation request for said delivery request status is received from a user terminal, whether or not information concerning a fixed delivery fee is received from said delivery company;
means for transmitting to the user, if said information concerning said fixed delivery fee has already been received, information concerning said purchased commodities included in information concerning the received delivery requests and said information concerning said fixed delivery fee;
means for transmitting to the user, if said information concerning said fixed delivery fee has not been received yet, information concerning said purchased commodities included in information concerning the received delivery requests and an estimate result of said delivery fee.

45. A delivery information processing apparatus, comprising:
means for receiving a delivery request to deliver a purchased commodity from a purchase store is received; and
means for transmitting to a delivery company, after a predetermined timing, a packing instruction of purchased commodities meeting a predetermined condition among all purchased commodities relating to said delivery requests received before said predetermined timing.

46. A delivery request processing method, comprising the steps of:
transmitting a delivery request of a purchased commodity including information concerning the purchased commodity and a purchase store to a center server for at least each purchase store; and
transmitting to the center server, a request for start of collective delivery of purchased commodities satisfying a predetermined condition among all purchased commodities to a specified place.
